(19) United States
(12) Patent Application Publication
(10) Pub. No.: US 2007/0081719 A1
(43) Pub. Date: Apr. 12, 2007

(54) COLOR CONVERSION APPARATUS, METHOD, AND PROGRAM, IMAGE PROCESSING APPARATUS, AND IMAGE DISPLAY APPARATUS

(75) Inventor: Hidekuni MORIYA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/531,877

(22) Filed: Sep. 14, 2006

(30) Foreign Application Priority Data
Oct. 12, 2005 (JP) 2005-297057
Oct. 18, 2005 (JP) 2005-303379

(51) Int. Cl. G06K 9/00

(52) U.S. Cl. 382/162

(57) ABSTRACT

A color conversion apparatus performs color conversion of input image data in which the number of a plurality of colors used in the input image data is changed to the number of a plurality of colors used in a display device for displaying an image. The apparatus includes a predetermined-point color-conversion-value calculator that calculates color conversion values corresponding to each of a plurality of predetermined points at least including a point outside a color reproduction region that can be displayed by the display device in a color space; and an interpolation calculator that performs the color conversion by performing interpolation calculation on the input image data using the color conversion values corresponding to each of the predetermined points.

### BACKGROUND

1. Technical Field

The present invention relates to color conversion apparatuses, methods, and programs for performing color conversion of input image data.

2. Related Art

Image display apparatuses capable of displaying images using four or more than four primary colors (hereinafter may also be referred to as “multiple primary colors”) have been known. Since input image data is of three primary colors, such image display apparatuses capable of displaying multiple primary colors convert the image data into image data of the multiple primary colors (e.g., four primary colors). For example, Japanese Unexamined Patent Application Publication Nos. 2000-338950 and 2004-362573 describe methods of dividing a color reproduction region into a plurality of pyramidal regions and calculating the primary colors RGBC in each region. In this case, regions to which the primary colors RGBC belong are obtained by determining whether conditions for the calculated primary colors RGBC are satisfied.

However, the techniques described in the above patent documents may sometimes be unable to perform appropriate color conversion of image data positioned outside the color reproduction region. For example, there may be a gradation discontinuity between image data positioned inside the color reproduction region and image data positioned outside the color reproduction region.

### SUMMARY

An advantage of some aspects of the invention is that it provides a color conversion apparatus, method, and program, an image processing apparatus, and an image display apparatus with a display device, which are capable of performing appropriate color conversion while suppressing a gradation discontinuity at the boundary of a color reproduction region.

According to an aspect of the invention, there is provided a color conversion apparatus for performing color conversion of input image data in which the number of a plurality of colors used in the input image data is changed to the number of a plurality of colors used in a display device for displaying an image. The color conversion apparatus includes the following elements: a predetermined-point color-conversion-value calculator that calculates color conversion values corresponding to each of a plurality of predetermined points at least including a point outside a color reproduction region that can be displayed by the display device in a color space; and an interpolation calculator that performs the color conversion by performing interpolation calculation on the input image data using the color conversion values corresponding to each of the predetermined points.

The color conversion apparatus described above includes the predetermined-point color-conversion-value calculator and the interpolation calculator and is used to perform color conversion of input image data in which the number of a plurality of colors used in the input image data is changed to the number of a plurality of colors (e.g., four or more) used in a display device for displaying an image. The predetermined-point color-conversion-value calculator calculates color conversion values corresponding to each of a plurality of predetermined points at least including a point outside a color reproduction region. The interpolation calculator performs color conversion by performing interpolation calculation on the input image data using the color conversion values corresponding to each of the predetermined points. According to the color conversion apparatus described above, even when there are predetermined points outside and inside the boundary of the color reproduction region, values outside the color reproduction region are substantially the same, while values inside the color reproduction region change smoothly. Thus, a gradation discontinuity at the boundary of the color reproduction region that occurs upon color conversion can be suppressed, while color reproduction values for the plurality of colors can be accurately calculated.

It is preferable that the plurality of predetermined points at least include a point inside the color reproduction region. Thus, a gradation discontinuity that occurs between inside and outside the color reproduction region can be appropriately suppressed.

It is preferable that the interpolation calculator determine, on the basis of the input image data, a cube defined in the color space by the color conversion values corresponding to each of the predetermined points, obtain tetrahedrons by dividing the cube, and perform the interpolation calculation using the color conversion values corresponding to each of points defining each of the tetrahedrons. Thus, color conversion can be performed by simple processing.

It is preferable that the predetermined-point color-conversion-value calculator perform the calculation based on the color reproduction region divided into predetermined regions.

It is preferable that the predetermined-point color-conversion-value calculator calculate the color conversion values corresponding to each of the predetermined points using a conversion matrix for performing the color conversion in the color reproduction region. It thus becomes unnecessary to impose conditions of constraint to perform calculations, thereby suppressing noise generated by these conditions of constraint and performing highly accurate color conversion.

It is preferable that the conversion matrix be set using approximate points in the color reproduction region divided into predetermined regions.

It is preferable that the color reproduction region defined by N number of plural colors be divided into “N(N−1)−m” predetermined regions by obtaining “N(N−1)” outermost faces of the color reproduction region in the color space, extracting “N(N−1)−m” faces that do not contain black by excluding m (3<m<N) faces that contain black, and using quadrangular pyramids defined by k-th (1≦k≦N−2), (k+1)-th, and (k+2)-th degree colors and black.

It is preferable that the color conversion apparatus further include a linearizer that supplies image data obtained by linearizing the input image data to the predetermined-point color-conversion-value calculator and the interpolation calculator. Thus, accurate color reproduction values can be calculated.

It is preferable that the color conversion apparatus further include a non-linearizer that non-linearizes the color-converted image data. Thus, the display device can be allowed to display an image in an appropriate manner.

It is preferable that the predetermined points be 27 points arranged in a grid in the color space defined by the input colors.

It is preferable that the predetermined points be eight points arranged in a grid in the color space defined by the input colors.

It is preferable that the predetermined-point color-conversion-value calculator and the interpolation calculator output image data using four colors including red, green, blue, and cyan.

It is preferable that the predetermined-point color-conversion-value calculator and the interpolation calculator output image data using four colors including red, green, blue, and white.

It is preferable that the predetermined-point color-conversion-value calculator and the interpolation calculator output image data using five colors including red, green, blue, cyan, and white.

It is preferable that colorant regions of the plurality of colors include, within a visible light region where hue changes according to wavelength, a bluish hue coloration region, a reddish hue coloration region, and two hue coloration regions selected from among hues ranging from blue to yellow.

It is preferable that colorant regions of the plurality of colors include a coloration region where the peak of the wavelength of light passing therethrough is within 415-500 nm, a coloration region where the peak of the wavelength of light passing therethrough is greater than or equal to 600 nm, a coloration region where the peak of the wavelength of light passing therethrough is within 485-535 nm, and a coloration region where the peak of the wavelength of light passing therethrough is within 500-590 nm.

It is preferable that the color conversion apparatus further include a storage device that stores the color conversion values calculated by the predetermined-point color-conversion-value calculator. In this case, it is preferable that the interpolation calculator perform the color conversion based on the color conversion values stored in the storage device.

According to another aspect of the invention, there is provided a color conversion method for performing color conversion of input image data in which the number of a plurality of colors used in the input image data is changed to the number of a plurality of colors used in a display device for displaying an image. The method includes calculating color conversion values corresponding to each of a plurality of predetermined points at least including a point outside a color reproduction region that can be displayed by the display device in a color space; and performing the color conversion by performing interpolation calculation on the input image data using the color conversion values corresponding to each of the predetermined points.

According to a further aspect of the invention, there is provided a color conversion program for allowing a computer to perform color conversion of input image data in which the number of a plurality of colors used in the input image data is changed to the number of a plurality of colors used in a display device for displaying an image. The color conversion program allows the computer to function as predetermined-point color-conversion-value calculating means for calculating color conversion values corresponding to each of a plurality of predetermined points at least including a point outside a color reproduction region that can be displayed by the display device in a color space; and interpolation calculation means for performing the color conversion by performing interpolation calculation on the input image data using the color conversion values corresponding to each of the predetermined points.

According to the color conversion method and the color conversion program (including that recorded on a recording medium) described above, a gradation discontinuity at the boundary of the color reproduction region can be suppressed, and appropriate color conversion can be performed.

According to a still further aspect of the invention, there is provide an image processing apparatus including the following elements: a predetermined-point color-conversion-value calculator that calculates color conversion values corresponding to each of a plurality of predetermined points at least including a point outside a color reproduction region that can be displayed by a display device in a color space; and an interpolation calculator that uses the color conversion values corresponding to each of the predetermined points to perform color conversion of input image data in which the number of a plurality of colors used in the input image data is changed to the number of a plurality of colors used in the display device for displaying an image. According to the image processing apparatus described above, a gradation discontinuity at the boundary of the color reproduction region can be suppressed, and appropriate color conversion can be performed.

The image processing apparatus described above is preferably applicable to an image display apparatus including a display device that displays image data.

### BRIEF DESCRIPTION OF THE DRAWINGS

The invention will be described with reference to the accompanying drawings, wherein like numbers reference like elements, and wherein:

FIG. 1 is a block diagram showing the schematic configuration of an image display apparatus according to a first embodiment;

FIG. 2 is a block diagram showing the specific configuration of a color conversion circuit and a table storage memory according to the first embodiment;

FIG. 3 is a graph showing a specific example of an input-side 1-dimensional look-up-table (1DLUT);

FIG. 4 is a graph showing specific examples of output-side 1 DLUTs;

FIG. 5 is a diagram specifically illustrating color conversion;

FIGS. 6A to 6H show quadrangular pyramids obtained by dividing a polyhedron representing a color reproduction region;

FIG. 7 is a flowchart showing a color-reproduction-region dividing process;

FIG. 8 is a flowchart showing a color conversion entire process;

FIG. 9 is a flowchart showing a color conversion process;

FIG. 10 is a diagram illustrating a method of calculating R2, G2, B2, and C2;

FIG. 11 is a flowchart showing a color-conversion-value calculating process;

FIG. 12 is a diagram illustrating an out-of-color-gamut calculation process;

FIG. 13 is a flowchart showing the out-of-color-gamut calculation process;

FIG. 14 is a flowchart showing an output-value calculating method;

FIGS. 15A and 15B are diagrams illustrating a first region determination performed in an interpolation calculation process;

FIGS. 16A to 16F are diagrams illustrating a second region determination performed in the interpolation calculation process;

FIG. 17 is a table showing conditions for use in the second region determination and parameters for use in the interpolation calculation;

FIG. 18 is a flowchart showing the interpolation calculation process;

FIG. 19 is a flowchart showing a color-conversion-value calculating method according to a second embodiment;

FIG. 20 is a flowchart showing a matrix calculation process;

FIG. 21 is a diagram showing how RGBC are specified in the matrix calculation process;

FIG. 22 is a diagram showing the configuration of predetermined points for use in a third embodiment;

FIG. 23 is a flowchart showing an interpolation calculation process according to the third embodiment;

FIG. 24 is a block diagram showing the schematic configuration of a color conversion circuit and a table storage memory according to a fourth embodiment;

FIG. 25 is a diagram showing an example of a color reproduction region defined by primary colors including RGBWh;

FIGS. 26A to 26I are diagrams showing color reproduction regions obtained by dividing a polyhedron in the fourth embodiment;

FIG. 27 is a block diagram showing the schematic configuration of a color conversion circuit and a table storage memory according to a fifth embodiment;

FIG. 28 is a diagram showing an example of a color reproduction region defined by primary colors including RGBCWh;

FIGS. 29A to 29P are diagrams showing color reproduction regions obtained by dividing a polyhedron in the fifth embodiment; and

FIG. 30 is a block diagram showing the schematic configuration of an image display apparatus according to a modification of the invention.

### DESCRIPTION OF EXEMPLARY EMBODIMENTS

Preferred embodiments of the invention will be described with reference to the drawings. The case of an image display apparatus capable of displaying an image using four or more than four primary colors (multiple primary colors) will be described hereinafter by way of example.

First Embodiment

A first embodiment of the invention will be described.

Entire Configuration

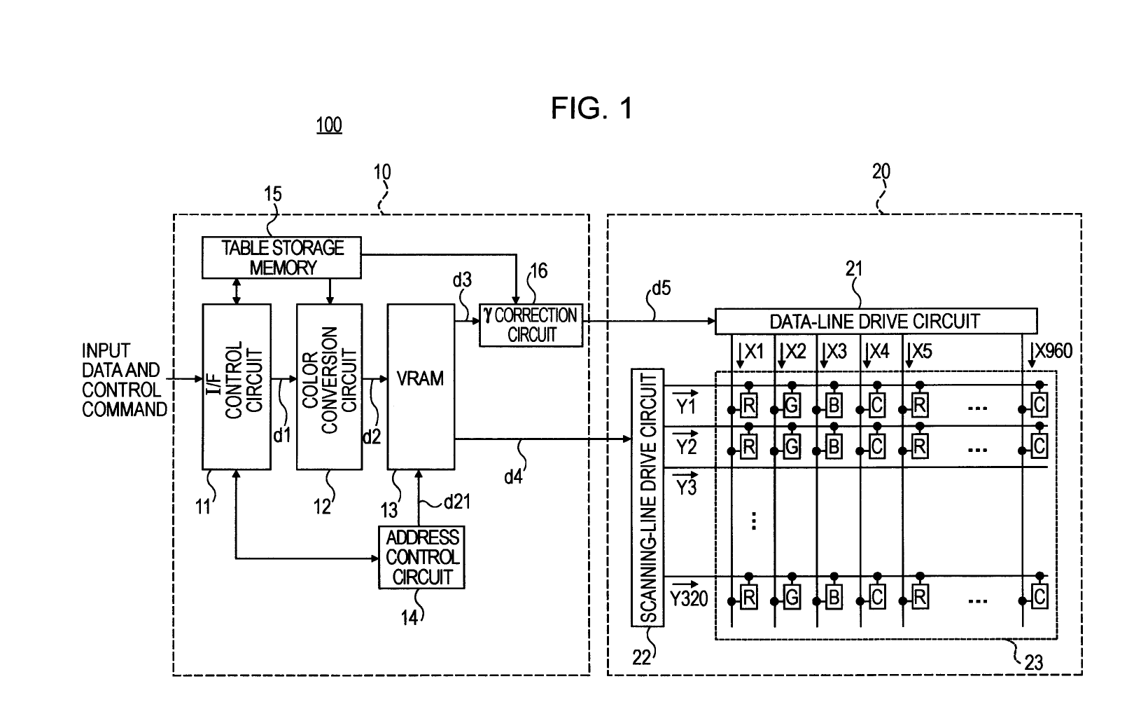

FIG. 1 is a block diagram showing the schematic configuration of an image display apparatus 100 according to the first embodiment. The image display apparatus 100 includes an image processor 10 for obtaining image data and a control command from an external source and performing image processing on the image data and a display device 20 for displaying the image data that has been processed by the image processor 10. The image display apparatus 100 can display an image using multiple primary colors. Specifically, the image display apparatus 100 can display four primary colors including red, green, blue, and cyan (hereinafter may also be abbreviated as “R”, “G”, “B”, and “C”, respectively).

The image processor 10 includes an interface (I/F) control circuit 11, a color conversion circuit 12, a video random-access memory (VRAM) 13, an address control circuit 14, a table storage memory 15, and a gamma (γ) correction circuit 16. The I/F control circuit 11 obtains image data and a control command from an external source, e.g., a camera, and supplies image data d1 to the color conversion circuit 12. Image data supplied from an external source is of three primary colors R, G, and B.

The color conversion circuit 12 performs table conversion for converting gradation characteristics (hereinafter referred to as “1-dimensional look-up-table (1DLUT) conversion”) of the obtained image data d1 and conversion of the image data d1 in which the three primary colors are changed to four primary colors. In this case, the color conversion circuit 12 refers to data stored in the table storage memory 15 or the like and performs such conversion. Image data d2 that has been processed by the color conversion circuit 12 is written to the VRAM 13. The image data d2 written to the VRAM 13 is read on the basis of a control signal d21 from the address control circuit 14 by the γ correction circuit 16 as image data d3 and by a scanning-line drive circuit 22 in the display device 20 as address data d4. The γcorrection circuit 16 refers to the data stored in the table storage memory 15 or the like and performs γcorrection of the obtained image data d3. The γcorrection circuit 16 supplies γ-corrected image data d5 to a data-line drive circuit 21 in the display device 20.

The display device 20 includes the data-line drive circuit 21, the scanning-line drive circuit 22, and a display panel 23. The data-line drive circuit 21 supplies data-line drive signals X1 to X960 to 960 associated data lines. The scanning-line drive circuit 22 supplies scanning-line drive signals Y1 to Y320 to 320 associated scanning lines. In this case, the data-line drive circuit 21 and the scanning-line drive circuit 22 drive the display panel 23 in synchronization with each other. The display panel 23 includes a liquid crystal display (LCD) or the like and displays characters and images to be displayed in response to voltage application to the scanning lines and the data lines.

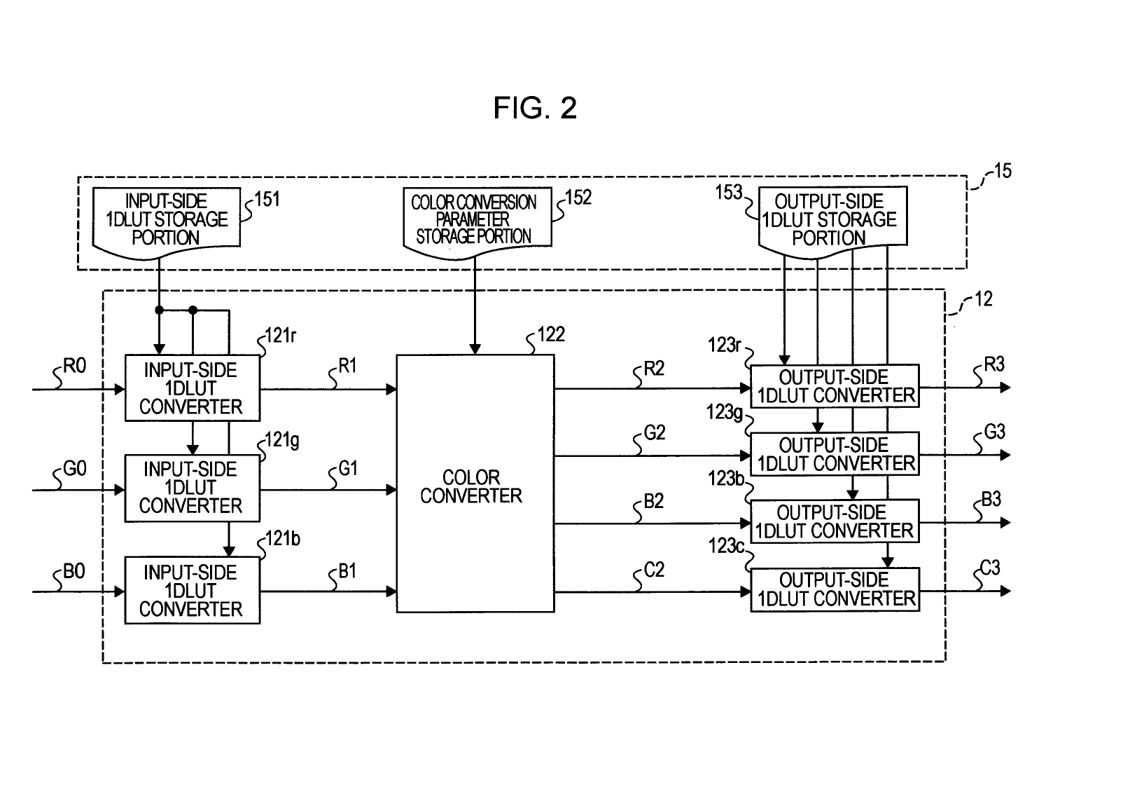

FIG. 2 is a block diagram showing the specific configuration of the color conversion circuit 12 and the table storage memory 15. The color conversion circuit 12 includes input-side 1DLUT converters 121r, 121g, and 121b, a color converter 122, and output-side 1DLUT converters 123r, 123g, 123b, and 123c. The table storage memory 15 includes an input-side 1DLUT storage portion 151, a color conversion parameter storage portion 152, and an output-side 1DLUT storage portion 153.

The input-side 1DLUT converters 121r to 121b perform 1DLUT conversion (hereinafter referred to as “input-side 1DLUT conversion”) of input image data R0, G0, and B0 using 1DLUT stored in the input-side 1DLUT storage portion 151 (hereinafter referred to as “input-side 1DLUT”). Such input-side 1DLUT conversion is performed to linearize the input image data R0, G0, and B0 because the input image data R0, G0, and B0 have generally been γ-converted by a camera or the like. The image data R0, G0, and B0 correspond to the image data d1 described above. The image data R0 is data corresponding to the primary color red; the image data G0 is data corresponding to the primary color green; and the image data B1 is data corresponding to the primary color blue (hereinafter the reference symbols “R”, “G”, “B”, and “C” with subsequent numerals represent data representing the primary colors). In this manner, the input-side 1DLUT converters 121r to 121b function as a linearizer.

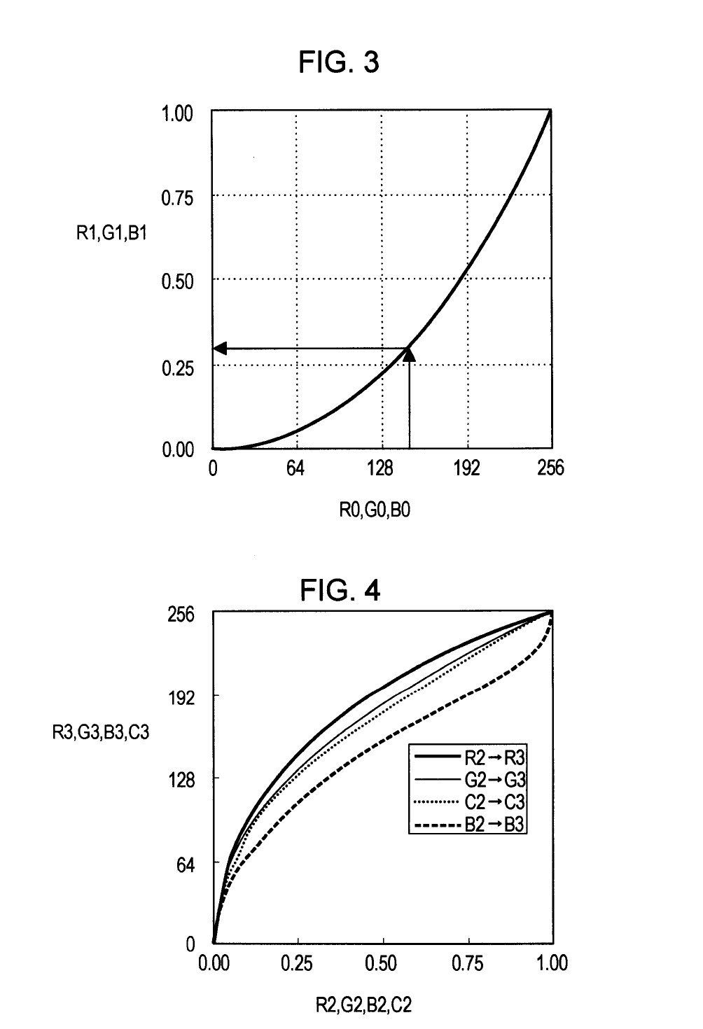

FIG. 3 shows a specific example of the input-side 1DLUT, where the horizontal axis shows the image data R0, G0, and B0 input to the input-side 1DLUT converters 121r to 121b, respectively, and the vertical axis shows image data R1, G1, and B1 (that is, image data subsequent to the input-side 1DLUT conversion) output from the input-side 1DLUT converters 121r to 121b, respectively. In this case, the input-side 1DLUT conversion is performed individually on the input image data R0, G0, and B0, although the same input-side 1DLUT is used.

Referring back to FIG. 2, the above-described input-side-1DLUT-converted image data R1, G1, and B1 are supplied to the color converter 122. The color converter 122 uses color conversion parameters (e.g., color conversion values corresponding to each of predetermined points, which will be described subsequently) stored in the color conversion parameter storage portion 152 to perform color conversion of the supplied image data R1, G1, and B1 in which the three primary colors are changed to the four primary colors. Specifically, the color converter 122 performs color conversion in which the three primary colors RGB are changed to the four primary colors RGBC additionally including cyan. The color converter 122 supplies color-converted image data R2, G2, B2, and C2 to the output-side 1DLUT converters 123r to 123c, respectively. In this manner, the color converter 122 functions as a predetermined-point color-conversion-value calculator and an interpolation calculator. Details of color conversion performed by the color converter 122 will be described subsequently.

The output-side 1DLUT 123r to 123c perform 1DLUT conversion (hereinafter referred to as “output-side 1DLUT conversion”) of the image data R2, G2, B2, and C2 using 1DLUTs stored in the output-side 1DLUT storage portion 153 (hereinafter referred to as “output-side 1DLUTs”). The output-side 1DLUT converters 123r to 123c output -side-1DLUT-converted image data R3, G3, B3, and C3, respectively, to the VRAM 13. The image data R3, G3, B3, and C3 correspond to the image data d2 described above. In this manner, the output-side 1DLUT converters 123r to 123c function as a non-linearizer.

FIG. 4 shows specific examples of the output-side 1DLUTs, where the horizontal axis shows the image data R2, G2, B2, and C2 input to the output-side 1DLUT converters 123r to 123c, respectively, and the vertical axis shows the image data R3, G3, B3, and C3 (that is, image data subsequent to the output-side 1DLUT conversion) output from the output-side 1DLUT converters 123r to 123c, respectively. In this case, the output-side 1DLUT conversion is performed individually on the input image data R2, G2, B2, and C2 using the different output-side 1DLUTs for the image data R2, G2, B2, and C2.

Color Conversion Method

A color conversion method according to the first embodiment will now be described.

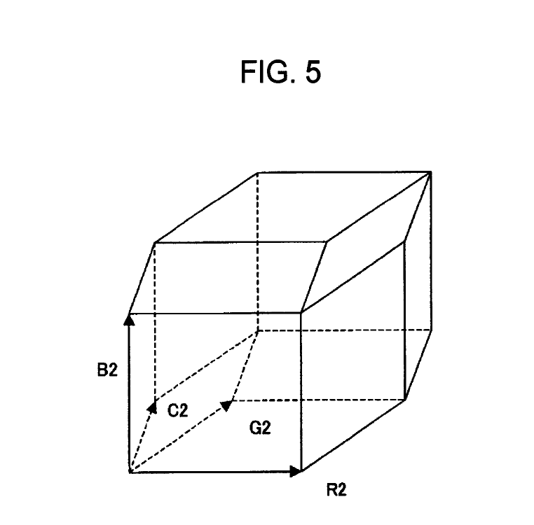

The basic concept of color conversion will be described with reference to FIGS. 5 to 7.

FIG. 5 specifically illustrates color conversion. That is, FIG. 5 is a diagram showing a color reproduction region as a polyhedron. This polyhedron is defined by vectors corresponding to the primary colors. In the case of N primary colors, the color reproduction region is an N(N−1)−hedron. In this case, since the image data R2, G2, B2, and C2 are of four primary colors, the color reproduction region is a dodecahedron. Color conversion is performed to represent three stimuli X, Y, and Z using R2, G2, B2, and C2. Specifically, the image data R1, G1, and B1 subsequent to the input-side 1DLUT conversion are multiplied by a matrix M to obtain three stimuli Xi, Yi, and Zi representing colors (see the following equation (1)). The matrix M is determined in advance on the basis of characteristics or the like of the image display apparatus 100:

$$( \begin{matrix}\begin{matrix}Xi \\ Yi\end{matrix} \\ Zi\end{matrix} ) = M ( \begin{matrix}\begin{matrix}R 1 \\ G 1\end{matrix} \\ C 1\end{matrix} )$$

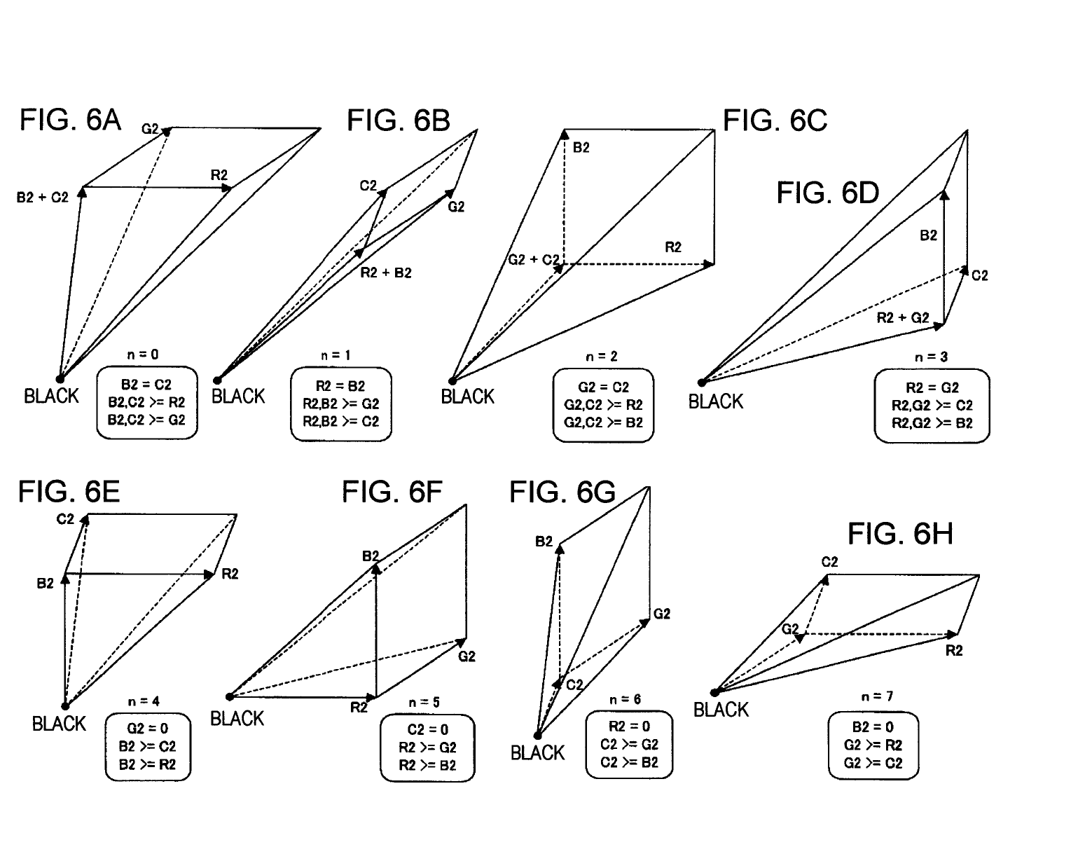

FIGS. 6A to 6H show quadrangular pyramids obtained by dividing the polyhedron representing the color reproduction region. As has been described above, the purpose of color conversion is to represent the three stimuli X, Y, and Z using R2, G2, B2, and C2. Since the number of variables to be obtained is greater than the number of dimensions, the polyhedron representing the color reproduction region is divided to give conditions of constraint to the variables. That is, the number of variables is reduced to perform color conversion calculation. Specifically, as shown in FIGS. 6A to 6H, all eight regions are quadrangular pyramids, and the vertex where four edges come together represents black. The quadrangular pyramid shown in FIG. 6A (where “n=0”) will be described by way of representative example. This quadrangular pyramid is defined by three vectors “B2+C2”, “R2”, and “G2”, and the condition of constraint “B2=C2” is given to the variables. In this case, “B2, C2≧R2” and “B2, C2≧G2” are the conditions for input image data to be inside the quadrangular pyramid.

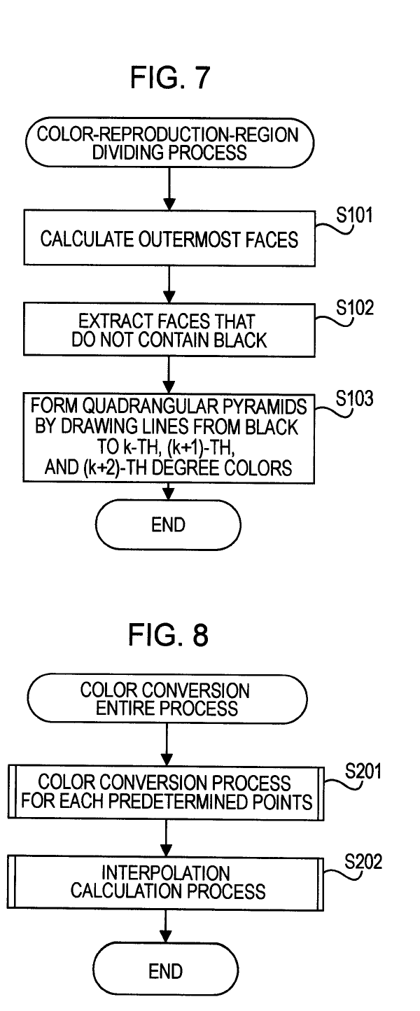

FIG. 7 is a flowchart showing a process of dividing a polyhedron representing a color reproduction region (color-reproduction-region dividing process). In step S101, primary colors of the color reproduction region are used to form outermost faces of the color reproduction region. The number of outermost faces where the number of primary colors is N is “N(N−1)”. When the processing in step S101 ends, the flow proceeds to step S102. In step S102, faces that do not contain black are extracted. The number of faces that contain black is N at maximum when all the primary colors are positioned outside the color reproduction region and is m (3≦m≦N) when some of the primary colors are positioned inside the color reproduction region. Thus, the number of faces that do not contain black is “N(N−1)−m”. The faces that do not contain black can be represented as k-th, (k+1)-th, and (k+2)-th degree colors. Here, k-th degree colors can be obtained by adding k primary colors. In the case of N primary colors, the maximum degree is N-th degree colors. Thus, the range of k is “1≦k≦(N−2)”. There are two (k+1)-th degree colors on each outermost face (although the number of (k+1)-th degree colors is greater than two, there are two (k+1)-th degree colors on each outermost surface).

In step S103, straight lines are drawn from black to the k-th, (k+1)-th, and (k+2)-th degree colors on the extracted faces that do not contain black. With these lines and the faces that do not contain black, the color reproduction region is divided to form quadrangular pyramids. Accordingly, the color reproduction region is divided into “N(N−1)−m” quadrangular pyramids.

Next, a color conversion method according to the first embodiment will be described. In the first embodiment, a plurality of predetermined points in a three-dimensional color space are set, and color conversion values (values represented by the primary colors RGBC) corresponding to each of the predetermined points are obtained. The predetermined points, the number of which is finite, are arranged in, for example, a grid in the color space and are set in advance. That is, the plurality of predetermined points include those inside the color reproduction region and those outside the color reproduction region. A space among the plurality of predetermined points covers the color reproduction region defined by the primary colors.

In the first embodiment, color conversion is performed on input image data using color conversion values corresponding to each of predetermined points. Specifically, color conversion is performed by performing interpolation calculation using color conversion values corresponding to each of predetermined points.

FIG. 8 is a flowchart showing a color conversion entire process. This process is performed by the color converter 122 described above.

In step S201, the color converter 122 calculates color conversion values corresponding to each of a plurality of predetermined points determined in advance. Then, the flow proceeds to step S202. In step S202, the color converter 122 performs color conversion by performing interpolation calculation using the color conversion values corresponding to each of the predetermined points. Then, the process exits from this flow.

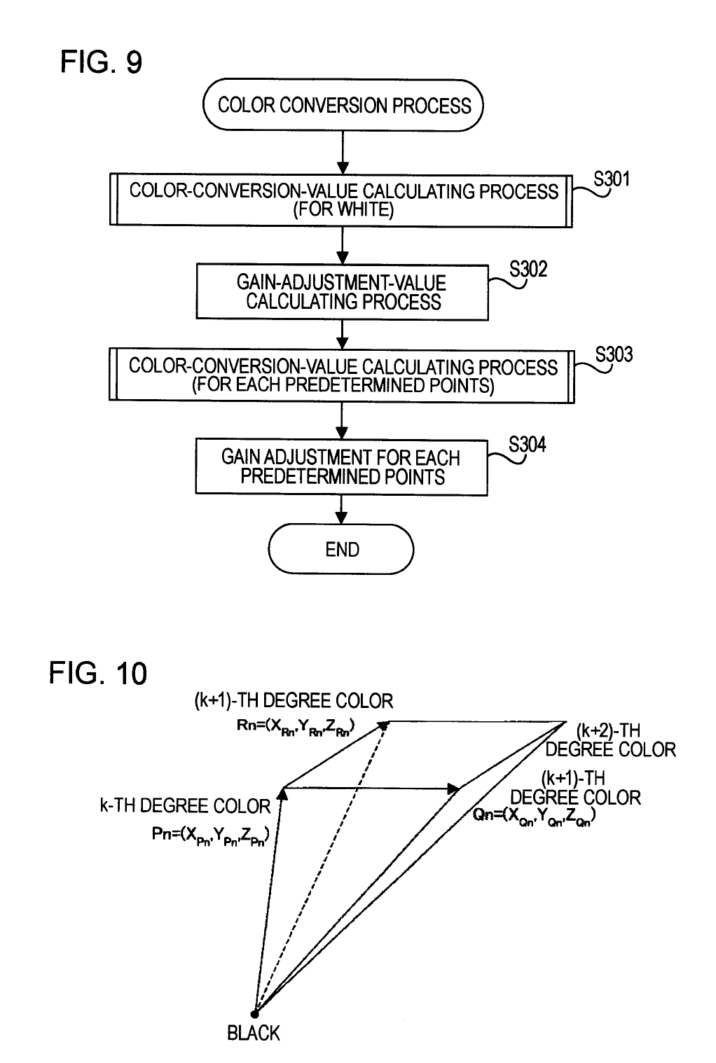

FIGS. 9 to 14 specifically illustrate the color conversion process for each of the predetermined points (the processing in step S201).

FIG. 9 is a flowchart illustrating the overall flow of the above-described color conversion process for each of the predetermined points (the processing in step S201 of the flowchart shown in FIG. 8). This process is performed also by the color converter 122. p In step S301, the color converter 122 performs a color-conversion-value calculating process to calculate a color conversion value for white. Then, the flow proceeds to step S302. In this step, “white” indicates the value of white of the input image data and is the color in which R1, G1, and B1 all have maximum values. For example, when the value of each color ranges from zero to one, R1, G1, and B1 have the value one.

In step S302, the color converter 122 calculates a gain adjustment value based on the color conversion value for white calculated in step S302. The gain adjustment value is for adjusting color conversion values corresponding to each of predetermined points, which will be described subsequently. When the processing in step S302 ends, the flow proceeds to step S303.

In step S303, the color converter 122 performs the color-conversion-value calculating process for calculating color conversion values corresponding to each of the predetermined points set in advance. Then, the flow proceeds to step S304. In step S304, the color converter 122 adjusts the gain of the color conversion values corresponding to each of the predetermined points using the gain adjustment value calculated in step S302. The color converter 122 outputs the gain-adjusted color conversion values. When the processing described above ends, the process exists from this flow.

The above-described color-conversion-value calculating process will be specifically described. FIG. 10 illustrates a method of calculating color conversion values R2, G2, B2, and C2. A quadrangular pyramid obtained by dividing a polyhedron representing a color reproduction region is defined by three vectors Pn, Qn, and Rn (“Rn” has no connection with the color red). These vectors Pn, Qn, and Rn each have XYZ component values. To calculate R2, G2, B2, and C2, pn, qn, and rn are calculated using the XYZ components of the vectors Pn, Qn, and Rn and the three stimuli Xi, Yi, and Zi described above (“rn” has no connection with the color red). That is, the following calculation is performed:

$$( \begin{matrix}\begin{matrix}pn \\ qn\end{matrix} \\ rn\end{matrix} ) = {( \begin{matrix}{X}_{Pn} & {X}_{Qn} & {X}_{Rn} \\ {Y}_{Pn} & {Y}_{Qn} & {Y}_{Rn} \\ {Z}_{Pn} & {Z}_{Qn} & {Z}_{Rn}\end{matrix} )}^{- 1} ( \begin{matrix}\begin{matrix}Xi \\ Yi\end{matrix} \\ Zi\end{matrix} )$$

where n is an integer from 0 to 7.

When the calculated pn, qn, and rn satisfy predetermined conditions (hereinafter referred to as “conditions A”), R2, G2, B2, and C2 are calculated from pn, qn, and rn on the basis of the settings for R2, G2, B2, and C2 in the corresponding region. More specifically, the conditions A are:

$$\{ \begin{matrix}0 \leq pn , & qn , & rn \leq 1 \\ pn \geq qn & & \\ pn \geq rn & & \end{matrix}$$

Using the conditions A, it is possible to determine whether a point corresponding to pn, qn, and rn is positioned inside a divided quadrangular pyramid represented by n.

FIG. 11 is a flowchart showing the color-conversion-value calculating process. This process is performed in steps S301 and S303 in the color conversion process for each of the predetermined points shown in FIG. 9. The color-conversion-value calculating process is performed also by the color converter 122.

In step S401, the image data R1, G1, and B1 are input from the input-side 1DLUT converters 121r to 121b to the color converter 122. The image data R1, G1, and B1 are data corresponding to a predetermined point. Then, the flow proceeds to step S402. In step S402, the color converter 122 uses equation (1) to calculate the three stimuli Xi, Yi, and Zi. Then, the flow proceeds to step S403.

In step S403, the color converter 122 sets the variable n to zero, and the flow proceeds to step S404. In step S404, the color converter 122 uses equation (2) to calculate pn, qn, and rn, and the flow proceeds to step S405. In step S405, the color converter 122 determines whether pn, qn, and rn calculated in step S404 satisfy the conditions A expressed by expressions (3). That is, in step S405, it is determined whether a point corresponding to pn, qn, and rn is positioned in a divided region.

If pn, qn, rn satisfy the conditions A (yes in step S405), the flow proceeds to step S406. In this case, the point corresponding to pn, qn, and rn is positioned in the divided region. In step S406, the color converter 122 calculates R2, G2, B2, and C2 from pn, qn, and rn on the basis of the settings for R2, G2, B2, and C2 in the corresponding region, and outputs the calculated R2, G2, B2, and C2. Then, the process exits from this flow.

If pn, qn, and rn do not satisfy the conditions A (no in step S405), the flow proceeds to step S407. In this case, the point corresponding to pn, qn, and rn is not positioned in the divided region. In step S407, the color converter 122 determines whether the processing on all the divided regions has been completed. In other words, it is determined whether the variable n coincides with the number of primary colors N.

If the processing on all the regions has been completed (yes in step S407), the flow proceeds to step S408. In this case, pn, qn, and rn do not satisfy the conditions A in the cases of all the variables n, while the processing on all the regions has been completed. Thus, the point corresponding to pn, qn, and rn is not positioned inside the color reproduction region. In step S408, the color converter 122 performs a color-conversion-value calculating process for the point outside the color reproduction region (hereinafter this process is referred to as an “out-of-color-gamut calculation process”). When the out-of-color-gamut calculation process ends, the process exits from this flow.

If the processing on all the regions has not been completed yet (no in step S407), the flow proceeds to step S409. In this case, the point corresponding to pn, qn, and rn calculated in the case of the current variable n is not positioned within the color reproduction region, but the processing on all the regions has not been completed yet. Thus, the variable n is changed, and the processing is again performed. Specifically, in step S409, the color converter 122 adds one to the variable n. Then, the flow returns to step S404. That is, the processing described above is performed using the new variable n.

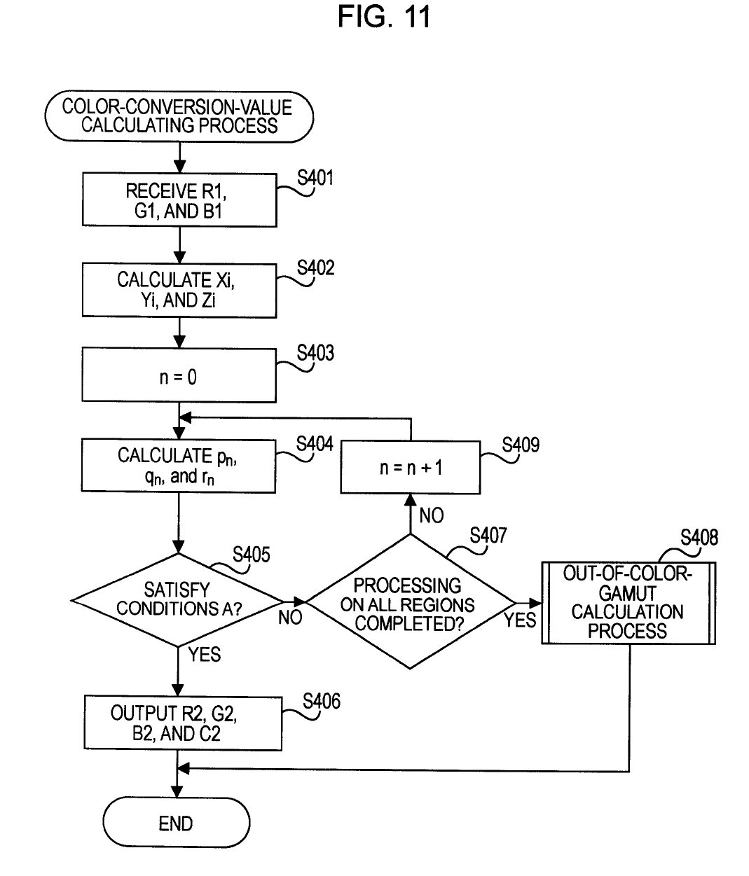

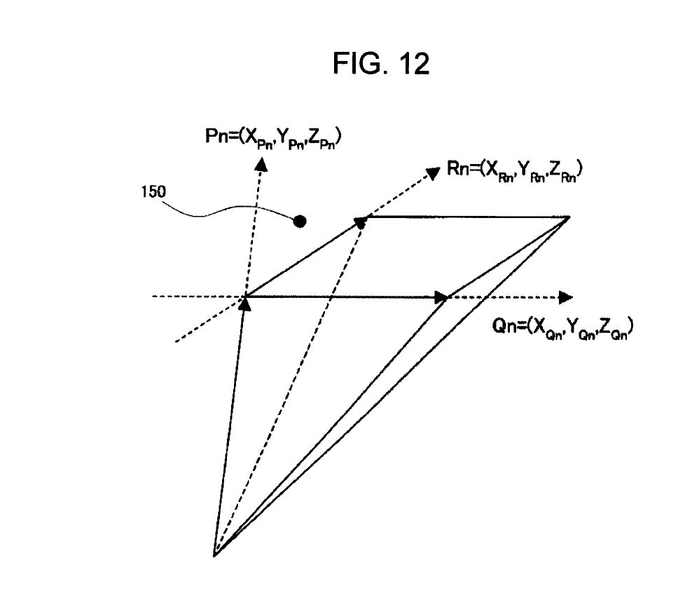

The out-of-color-gamut calculation process described above will be described with reference to FIGS. 12 to 14.

FIG. 12 illustrates the basic concept of the out-of-color-gamut calculation process. The out-of-color-gamut calculation process is a process performed for a predetermined point, such as a point 150, existing outside the color reproduction region. Using equation (2), pn, qn, and rn are calculated. This time, conditions for pn, qn, and rn for performing determination (hereinafter referred to as “conditions B”) are different from the conditions A. The conditions B are a modified version of the conditions A. That is, according to the conditions B, pn may be a value greater than one (though pn cannot be a value less than zero) and qn and rn can be arbitrary values. More specifically, the conditions B are expressed as:

$$\{ \begin{matrix}\begin{matrix}0 \leq pn \\ pn > qn\end{matrix} \\ pn > rn\end{matrix}$$

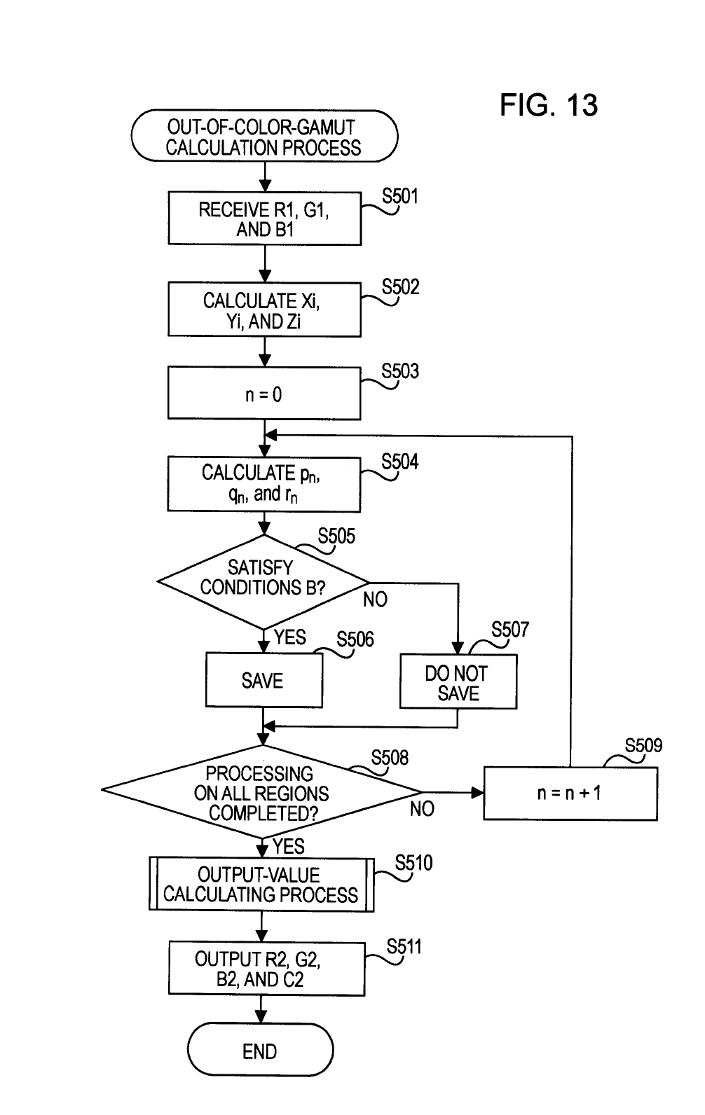

FIG. 13 is a flowchart showing the out-of-color-gamut calculation process. This process is performed by the color converter 122 in step S408 in the color-conversion-value calculating process shown in FIG. 11.

Since the processing in steps S501 to S504 is similar to that in steps S401 to S404 described above, a description thereof is omitted.

In step S505, the color converter 122 determines whether pn, qn, and rn calculated in step S504 satisfy the conditions B expressed by expressions (4). When pn, qn, and rn satisfy the conditions B (yes in step S505), the flow proceeds to step S506. In step S506, the color converter 122 saves the calculated pn, qn, and rn. Then, the flow proceeds to step S508. In contrast, if pn, qn, and rn do not satisfy the conditions B (no in step S505), the flow proceeds to step S507. In step S507, the color converter 122 does not save the calculated pn, qn, and rn. Then, the flow proceeds to step S508. Since the conditions B are less stringent, a plurality of sets of pn, qn, and rn are saved for one predetermined point by repeating the processing in steps S504 to S509.

In step S508, the color converter 122 determines whether the processing on all the divided regions has been completed. In other words, it is determined whether the variable n coincides with the number of primary colors N. If the processing on all the regions has been completed (yes in step S508), the flow proceeds to step S510.

In contrast, if the processing on all the regions has not been completed yet (no in step S508), the flow proceeds to step S509. In this case, pn, qn, and rn calculated in the case of the current variable n do not satisfy the conditions B, but the processing on all the regions has not been completed yet. Thus, the variable n is changed to the next value, and the processing is again performed. Specifically, in step S509, the color converter 122 adds one to the variable n. Then, the flow returns to step S504. That is, the processing described above is performed using the new variable n.

In step S510, the color converter 122 performs an output-value calculating process. Specifically, the color converter 122 selects one set of pn, qn, and rn from among the plurality of sets of saved pn, qn, and rn. When the output-value calculating process is completed, the flow proceeds to step S511. In step S511, the color converter 122 calculates R2, G2, B2, and C2 from the selected pn, qn, and rn, and outputs the calculated R2, G2, B2, and C2. Here, R2, G2, B2, and C2 output from the color converter 122 are values that have not been subjected to a limiter or the like, which will be described subsequently, and that accurately reproduce the three stimuli X, Y, and Z. When the processing described above ends, the process exits from this flow.

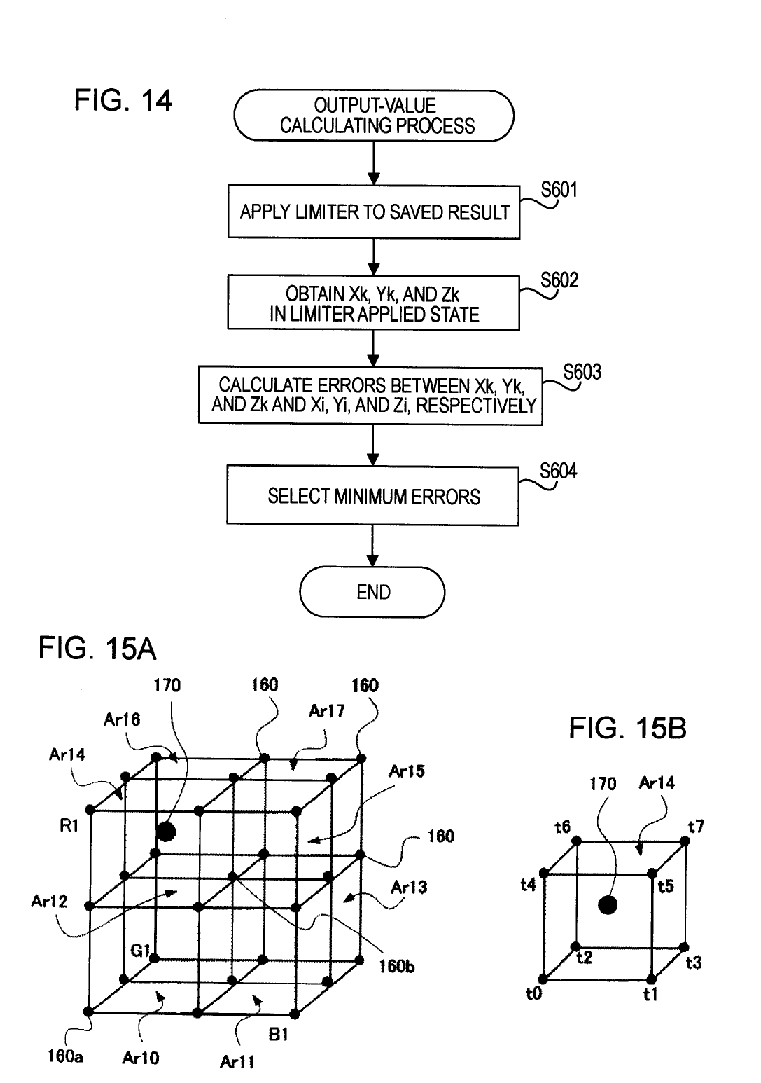

FIG. 14 is a flowchart showing the output-value calculating process described above. This process is performed by the color converter 122 in step S510 in the out-of-color-gamut calculation process shown in FIG. 13.

In step S601, the color converter 122 obtains a plurality of sets of R2, G2, B2, and C2 from the plurality of sets of saved pn, qn, and rn, and applies a limiter to the obtained sets of R2, G2, B2, and C2. Hereinafter, R2, G2, B2, and C2 that have been subjected to a limiter are denoted as “R21, G21, B21, and C21”, respectively. The phrase “subjected to a limiter” means limiting R2, G2, B2, and C2 less than zero or greater than one to be within a range from zero to one. When the processing in step S601 ends, the flow proceeds to step S602.

In step S602, the color converter 122 calculates three stimuli Xk, Yk, and Zk from a plurality of sets of limiter-applied R21, G21, B21, and C21. Then, the flow proceeds to step S603. In step S603, the color converter 122 calculates errors between the limiter-applied three stimuli Xk, Yk, and Zk and the original three stimuli Xk, Yk, and Zk that have not been subjected to a limiter. In this case, since the plurality of sets of pn, qn, and rn have been saved, there is a plurality of sets of limiter-applied three stimuli Xk, Yk, and Zk. As a result, a plurality of errors are calculated. Then, the flow proceeds to step S604.

In step S604, the color converter 122 selects the minimum errors from among the plurality of errors calculated in step S603. Then, the color converter 122 outputs a set of R2, G2, B2, and C2 for which the errors have been selected. The color converter 122 does not output the limiter-applied R21, G21, B21, and C21, but outputs the R2, G2, B2, and C2 that have not been subjected to a limiter. When the processing described above ends, the process exits from this flow.

The interpolation calculation process (in step S202 of FIG. 8) described above will be described with reference to FIGS. 15A to 18.

In the first embodiment, a region determination is performed on input image data in a space defined by predetermined points. On the basis of the region determination result, predetermined points for use in the input image data are selected, and a method for using the predetermined points is determined. More specifically, the region determination includes a first region determination performed at first and a second region determination performed subsequently.

FIGS. 15A and 15B illustrate the first region determination described above. FIG. 15A shows an example of a solid body defined by predetermined points. In this case, 27 predetermined points 160 (including points 160a and 160b) are arranged in a grid at equal intervals, and each edge includes three predetermined points 160 to form a cube (hereinafter referred to as a “fist cube”). It is assumed that the first cube covers the color reproduction region. The predetermined points 160 exist in a space defined by R1, B1, and G1, and the predetermined points 160 each have color conversion values (R2, B2, G2, and C2 ) calculated by performing the color conversion described above. Also, R1, B1, and G1 satisfy “0≦R1, B1, G1≦1”. Since the first cube covers the color reproduction region, at least the predetermined point 160a representing black and the predetermined point 160b positioned at the center of the first cube are contained in the color reproduction region. To be precise, the predetermined point 160a representing black exists on the outermost faces of the color reproduction region.

The first cube defined by the 27 predetermined points 160 includes solid bodies Ar10 to Ar17 (hereinafter referred to as “second cubes”) defined by eight predetermined points 160. There are eight second cubes Ar10 to Ar17. In the first region determination, the second cube that contains input image data is selected from among the second cubes Ar10 to Ar17.

The first region determination performed by the color converter 122 will now be described. On the basis of R1, G1, and B1 corresponding to input image data, the color converter 122 selects the second cube Ar14 in which a point indicating the image data is positioned. For example, when the input image data is positioned at a point 170, R1, G1, and B1 are such that “0.5<R1<1”, “0<G1<0.5”, and “0<B1<0.5”. Thus, the color converter 122 selects the second cube Ar14.

FIG. 15B shows the details of the selected second cube Ar14. The predetermined points 160 defining the second cube Ar14 are redefined as “t0 to t7”. The position (coordinates) of the input point 170 within the second cube Ar14 is defined as “r1, g1, b1”, which satisfy “0≦r1, g1, b1≦1”. These r1, g1, and b1 can be obtained from R1, G1, and B1 representing the original image data.

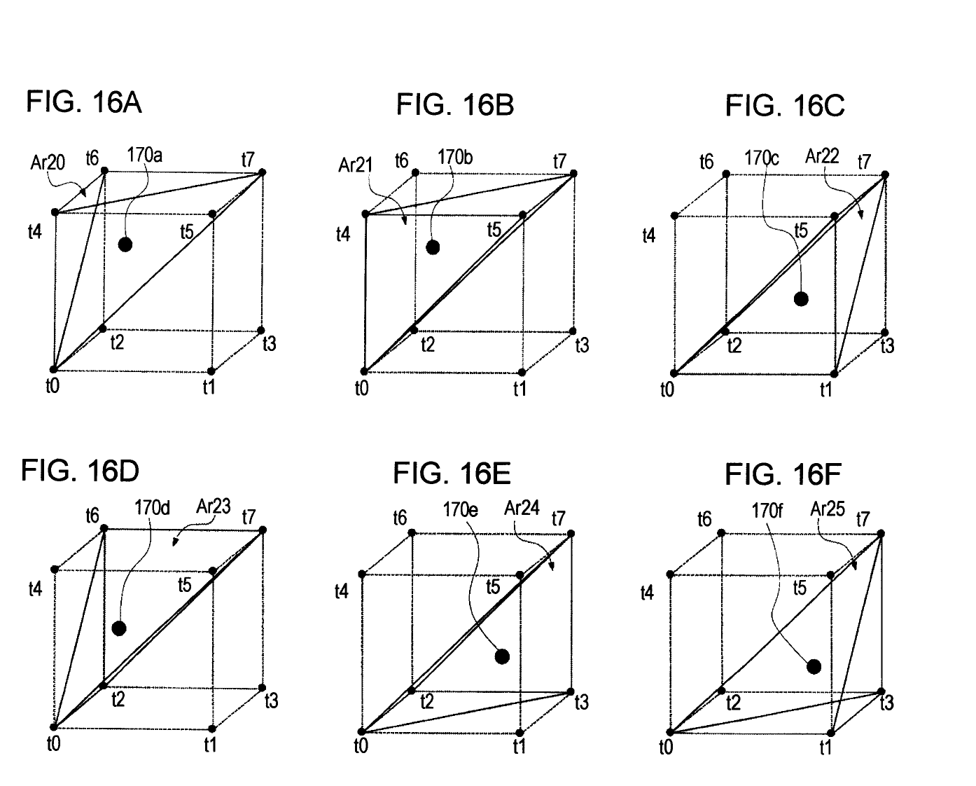

FIGS. 16A to 16F illustrate the second region determination. Specifically, FIGS. 16A to 16F show six regions Ar20 to Ar25 obtained by dividing the second cube Ar14. These regions Ar20 to Ar25 are represented as tetrahedrons defined by the predetermined points t0 and t7 and two points selected from among the predetermined points t1 to t6. It is determined that input points 170a to 170f are contained within the regions Ar20 to Ar25, respectively, by performing the second region determination, which will be described subsequently, on the basis of r1, g1, and b1 indicating the position.

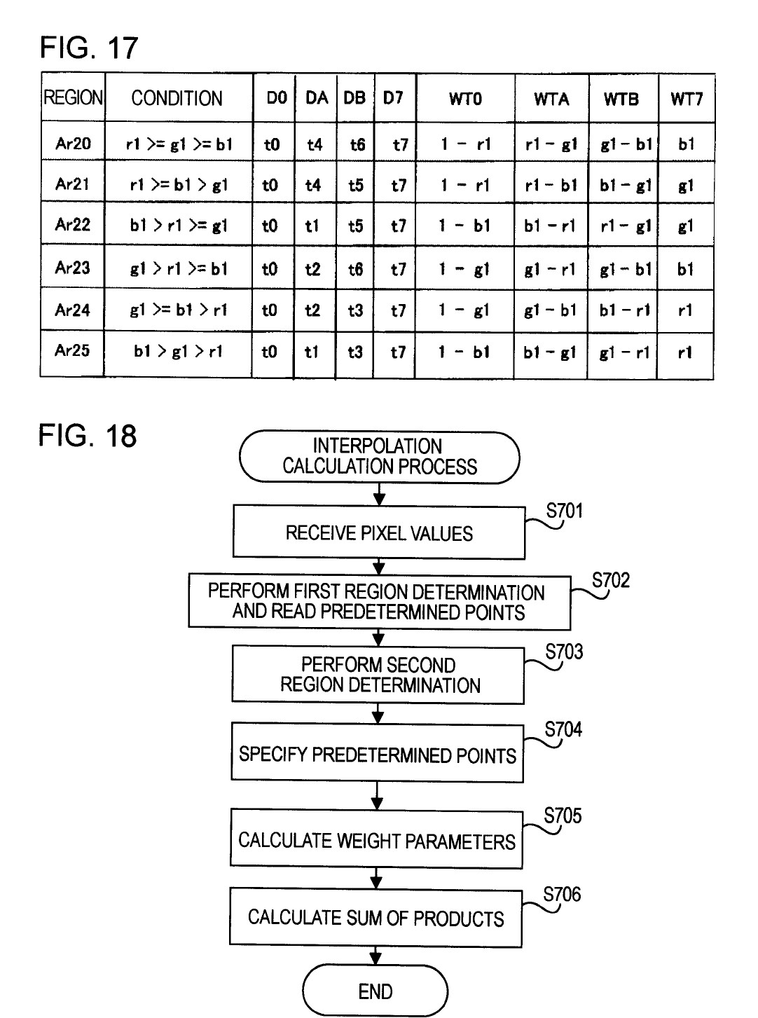

FIG. 17 is a table showing conditions for use in the second region determination and parameters for use in the interpolation calculation. FIG. 17 shows (from left to right) the regions Ar20 to Ar25 in which the input image data is positioned, the conditions for the input image data to be positioned inside the regions Ar20 to Ar25, points D0, DA, DB, and D7 defining the regions Ar20 to Ar25, and parameters WT0, WTA, WTB, and WT7 for use in the interpolation calculation (hereinafter the parameters are referred to as “weight parameters”). FIG. 17 shows (from top to bottom) the conditions and parameters corresponding to the regions Ar20 to Ar25.

More specifically, the color converter 122 uses the conditions shown in the table to determine in which of the regions Ar20 to Ar25 the input image data is positioned. At this time, the color converter 122 obtains predetermined points 160 defining a region that contains the image data. That is, the color converter 122 obtains four points from among the predetermined points t0 to t7 and defines these four points as D0, DA, DB, and D7, respectively. Basically, the point D0 corresponds to the predetermined point t0, and the point D7 corresponds to the predetermined point t7. The color converter 122 calculates weight parameters WT0, WTA, WTB, and WT7 corresponding to the selected region using r1, g1, and b1 (weight calculation). Next, the color converter 122 obtains color conversion values for the predetermined points corresponding to the points D0, DA, DB, and D7 and integrates the weight parameters WT0, WTA, WTB, and WT7 with the associated color conversion values. Then, the color converter 122 adds the integrated values (that is, the color converter 122 calculates the sum of the products).

Specifically, the color converter 122 performs interpolation calculation using the following equations (5) to obtain image data R2, G2, B2, and C2. Equations (5) represent the sum-of-products operations. By calculating R2, G2, B2, and C2 using equations (5), color conversion of the input image data is performed. In equations (5), R_{D0} to R_{D7}, G_{D0} to G_{D7}, B_{D0} to B_{D7}, and C_{D0} to C_{D7} represent color conversion values for the predetermined points 160 corresponding to the points D0, DA, DB, and D7.

$$\{ \begin{matrix}\begin{matrix}\begin{matrix}R 2 = {R}_{D 0} WT 0 + {R}_{DA} WTA + {R}_{DB} WTB + {R}_{D 7} WT 7 \\ G 2 = {G}_{D 0} WT 0 + {G}_{DA} WTA + {G}_{DB} WTB + {G}_{D 7} WT 7\end{matrix} \\ B 2 = {B}_{D 0} WT 0 + {B}_{DA} WTA + {B}_{DB} WTB + {B}_{D 7} WT 7\end{matrix} \\ C 2 = {C}_{D 0} WT 0 + {C}_{DA} WTA + {C}_{DB} WTB + {C}_{D 7} WT 7\end{matrix}$$

FIG. 18 is a flowchart showing the interpolation calculation process. This process is performed by the color converter 122.

In step S701, the color converter 122 obtains input image data. Specifically, the color converter 122 obtains R1, G1, and B1 of the input image data. Then, the flow proceeds to step S702. In step S702, the color converter 122 performs the first region determination on the input image data. Specifically, the color converter 122 selects one of the second cubes Ar10 to Ar17 that contains the input image data and reads eight predetermined points defining the selected second cube. Then, the flow proceeds to step S703.

In step S703, the color converter 122 performs the second region determination based on r1, g1, and b1 of the input image data. Specifically, the color converter 122 uses the conditions shown in FIG. 17 to determine in which of the regions Ar20 to Ar25 the input image data is contained. Then, the flow proceeds to step S704.

In step S704, the color converter 122 specifies predetermined points defining the region selected in step S703. Specifically, the color converter 122 obtains four points from among the predetermined points t0 to t7 and defines these four points as the points D0, DA, DB, and D7, respectively. Then, the flow proceeds to step S705. In step S705, the color converter 122 uses the table shown in FIG. 17 to calculate weight parameters WT0, WTA, WTB, and WT7 corresponding to the selected region using r1, g1, and b1 (weight calculation). Then, the flow proceeds to step S706.

In step S706, the color converter 122 obtains color conversion values for the predetermined points corresponding to the points D0, DA, DB, and D7, integrates the weight parameters WT0, WTA, WTB, and WT7 with the associated color conversion values, and adds the integrated values (the sum-of-products operation). Accordingly, color conversion of the input image data is performed. When the processing described above ends, the process exits from this flow.

According to the first embodiment, color conversion is accomplished by performing color conversion for each predetermined point and interpolation calculation. As has been described above, color conversion values obtained by performing color conversion for each predetermined point are values that have not been subjected to a limiter, and these values accurately reproduce the three stimuli Xi, Yi, and Zi. Weight parameters corresponding to input image data are calculated, and sum-of-products operations are performed using the weight parameters and the color conversion values corresponding to each of the predetermined points. With regard to input image data other than that corresponding to the color conversion values for each of the predetermined points, changes from color conversion values corresponding to a predetermined point to color conversion values corresponding to another predetermined point are smoothed by the weighting. In addition, even when there are predetermined points inside and outside the boundary of the color reproduction region, values outside the color reproduction region are substantially the same, while values inside the color reproduction region change smoothly. Thus, a gradation discontinuity can be suppressed (although the outside values saturate and result in so-called clipping, they are smooth in view of the changes from the inside). Thus, according to the first embodiment, color conversion into multiple primary colors can be appropriately performed.

According to the first embodiment, in the interpolation calculation process (see FIG. 18), the second cube is divided into six tetrahedrons, and linear interpolation calculation is performed using the weight parameters WT0, WTA, WTB, and WT7. In this case, since linearization (input-side 1DLUT conversion) and non-linearization (output-side 1DLUT conversion) are performed prior and subsequent to the interpolation calculation process, increases in the color components XYZ are linear with respect to increases in R2, G2, B2, and C2. Thus, correct color reproduction values can be obtained. Because the weight parameters WT0, WTA, WTB, and WT7 are obtained by inverse calculations using equations (5), linear interpolation calculation can be performed in a simple manner.

The invention is not limited to be applied to the display panel 23 (see FIG. 1) including pixels arranged in the order of RGBC from left to right, and the invention is also applicable to a display panel including RGBC pixels arranged in an order other than this order.

Although the case where there are 27 predetermined points has been described by way of example, the invention is not limited thereto. For example, 125 predetermined points may be used, and each edge may include five predetermined points to form a first cube. In addition, the invention is not limited to the case where predetermined points are set to form a cube. Alternatively, predetermined points may be set to form a rectangular parallelepiped instead of a cube.

The invention is not limited to the case where color conversion for each predetermined point is performed every time image data is input. Alternatively, color conversion values obtained by performing color conversion for each predetermined point may be stored in the table storage memory 15 (the color conversion parameter storage portion 152 to be precise), and color conversion (interpolation calculation) can be performed on input image data by referring to the stored color conversion values.

Second Embodiment

A second embodiment of the invention will be described. In the second embodiment, a color-conversion-value calculating process for calculating color conversion values corresponding to each of predetermined points is different from that in the first embodiment. Specifically, the second embodiment is different from the first embodiment in that color conversion values are calculated using a conversion matrix capable of performing color conversion. Since interpolation calculation similar to that in the first embodiment is performed in the second embodiment subsequent to the calculation of color conversion values corresponding to each of the predetermined points, a description thereof is omitted. Since the configuration of the image display apparatus 100 and the like is also similar to that in the first embodiment, a description thereof is omitted.

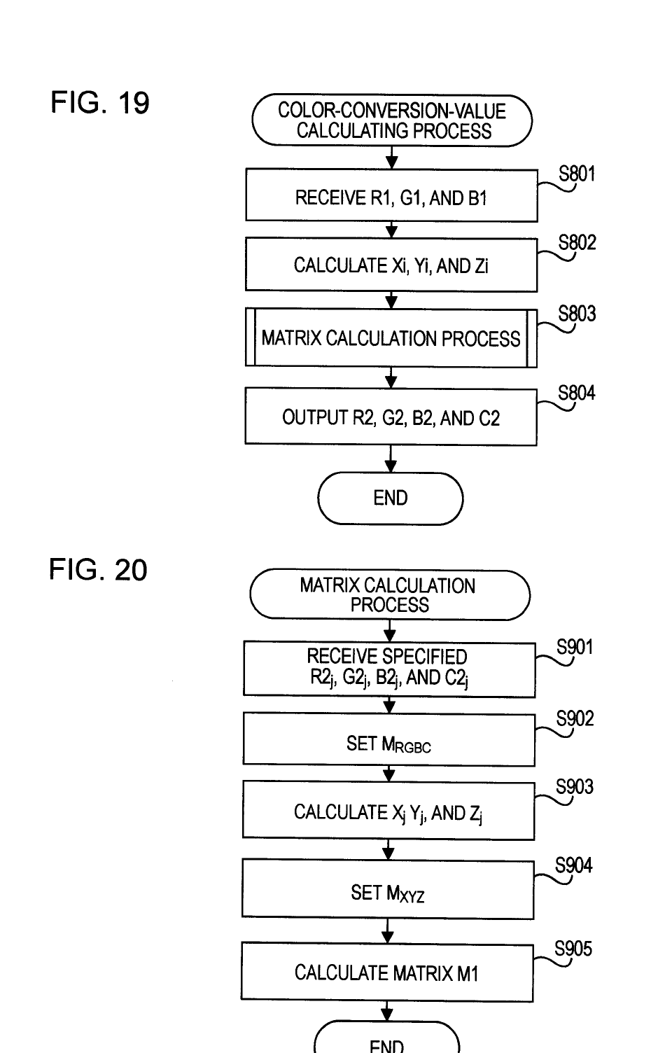

FIG. 19 is a flowchart showing the color-conversion-value calculating process according to the second embodiment. The process is performed also by the color converter 122 in the color conversion circuit 12 described above.

In step S801, the image data R1, G1, and B1 are input from the input-side 1DLUT converters 121r to 121b to the color converter 122. The image data R1, G1, and B1 are data corresponding to a predetermined point. Then, the flow proceeds to step S802. In step S802, the color converter 122 uses the above-described equation (1) to calculate the three stimuli Xi, Yi, and Zi. Then, the flow proceeds to step S803.

In step S803, the color converter 122 calculates a matrix for performing color conversion (matrix calculation process), and the flow proceeds to step S804. In step S804, the color converter 122 uses the calculated matrix to obtain R2, G2, B2, and C2 from Xi, Yi, and Zi. That is, the color converter 122 obtains color conversion values corresponding to the predetermined point when the processing described above ends, the process exits from this flow.

FIG. 20 is a flowchart specifically showing the matrix calculation process in step S803 described above. The process is performed also by the color converter 122.

In step S901, the color converter 122 obtains “J+1” sets of pre-specified R2ⱼ, G2ⱼ, B2ⱼ, and C2ⱼ inside the color reproduction region (j=0, . . . , J). Then, the flow proceeds to step S902. In step S902, the color converter 122 sets a matrix M_{RGBC} based on the obtained R2ⱼ, G2ⱼ, B2ⱼ, and C2ⱼ. The matrix M_{RGBC} is expressed as:

$${M}_{RGBC} = ( \begin{matrix}\begin{matrix}\begin{matrix}R {2}_{0} … R {2}_{j} … R {2}_{J} \\ G {2}_{0} … G {2}_{j} … G {2}_{J}\end{matrix} \\ B {2}_{0} … B {2}_{j} … B {2}_{J}\end{matrix} \\ C {2}_{0} … C {2}_{j} … C {2}_{J}\end{matrix} )$$

Then, the flow proceeds to step S903.

In step S903, the color converter 122 calculates Xⱼ, Yⱼ, and Zⱼ corresponding to R2, G2, B2, and C2 inside the color reproduction region, and the flow proceeds to step S904. In step S904, the color converter 122 uses the calculated Xⱼ, Yⱼ, and Zⱼ to set a matrix M_{XYZ}. The matrix M_{XYZ} is expressed as:

$${M}_{XYZ} = ( \begin{matrix}\begin{matrix}{X}_{0} … {X}_{j} … {X}_{J} \\ {Y}_{0} … {Y}_{j} … {Y}_{J}\end{matrix} \\ {Z}_{0} … {Z}_{j} … {Z}_{J}\end{matrix} )$$

Then, the flow proceeds to step S905.

In step S905, the color converter 122 calculates a matrix M1 from the calculated matrix M_{RGBC} and matrix M_{XYZ}, and the process exits from this flow. The matrix M1 is expressed as:

$$M 1 = {M}_{RGBC} {{M}_{XYZ}^{t} ( {M}_{XYZ} {M}_{XYZ}^{t} )}^{- 1}$$

When the number of primary colors is four including R2, G2, B2, and C2 , the matrix M1 has four rows and three columns and is a matrix for converting Xⱼ, Yⱼ, and Zⱼ to R2, G2, B2, and C2. In other words, the matrix M1 is an inverse matrix of a matrix for converting R2, G2, B2, and C2 to Xⱼ, Yⱼ, and Zⱼ (this matrix is referred to as “MO”). Since the matrix M0 is not a square matrix and it is impossible to directly obtain the inverse matrix of the matrix M0, as shown by equation (8), the matrix M1 is calculated as a pseudo-inverse matrix using a diagonal matrix of the matrix M_{XYZ}.

Using the matrix M1 calculated as described above, the color conversion values corresponding to the predetermined point can be obtained as:

$$( \begin{matrix}\begin{matrix}\begin{matrix}R {2}_{j} \\ G {2}_{j}\end{matrix} \\ B {2}_{j}\end{matrix} \\ C {2}_{j}\end{matrix} ) = M 1 ( \begin{matrix}\begin{matrix}{X}_{j} \\ {Y}_{j}\end{matrix} \\ {Z}_{j}\end{matrix} )$$

where R2ⱼ, G2ⱼ, B2ⱼ, and C2ⱼ are color conversion values corresponding to Xⱼ, Yⱼ, and Zⱼ.

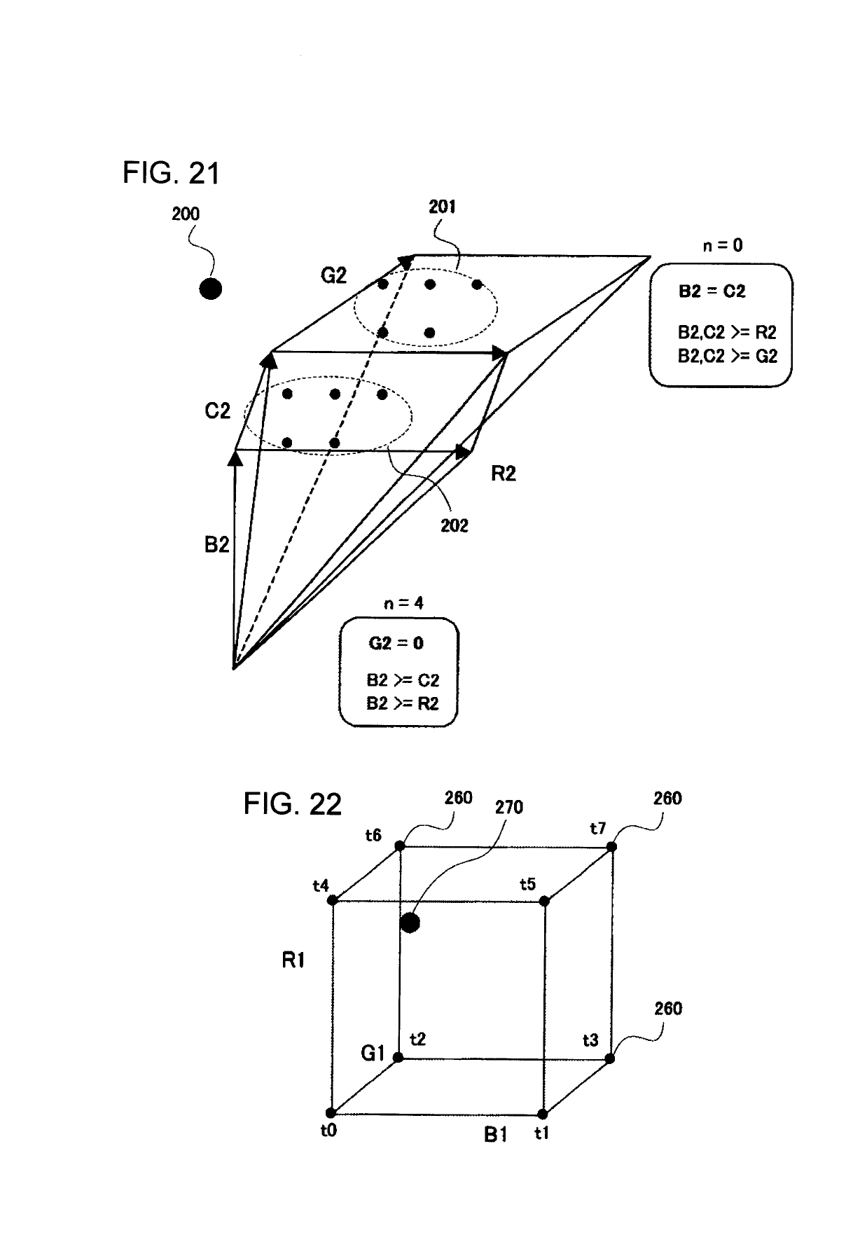

FIG. 21 illustrates how RGBC are specified in the matrix calculation process described above. With respect to a point 200 positioned outside the color reproduction region, RGBC are specified in regions where “n=0” and “n=4” among the divided color reproduction regions shown in FIGS. 6A to 6H. In this case, a plurality of points inside an area 201 indicated by broken lines are specified in the region where “n=0”, and a plurality of points inside an area 202 indicated by broken lines are specified in the region where “n=4”. These points correspond to R2ⱼ, G2ⱼ, B2ⱼ, and C2ⱼ obtained by the processing in step S901 described above. In the region where “n=0”, the condition of constraint “B2=C2” is imposed. In the region where “n=4”, the condition of constraint “G2=0” is imposed. In each of the regions, Xⱼ, Yⱼ, and Zⱼ corresponding to R2ⱼ, G2ⱼ, B2ⱼ, and C2ⱼ are set.

It is preferable that the above-described R2ⱼ, G2ⱼ, B2ⱼ, and C2ⱼ be set on the basis of the ratio of allocation of R2ⱼ, G2ⱼ, B2ⱼ, and C2ⱼ to Xⱼ, Yⱼ, and Zⱼ. Specifically, it is preferable that R2ⱼ, G2ⱼ, B2ⱼ, and C2ⱼ be set by taking into consideration the level of each color component R2ⱼ, G2ⱼ, B2ⱼ, and C2ⱼ, the arrangement of RGBC in an image on the image display device, or the like.

Advantages of the second embodiment will now be described. In the first embodiment, the condition of constraint is set on R2, G2, B2, and C2 in each of the divided regions, and thereafter, a calculation is performed. Because of the condition of constraint, the number of variables to be calculated coincides with the number of dimensions, and the calculation result is uniquely obtained. However, there are some cases where the calculation result such as “B2=C2” or “G2=0” reflecting the condition of constraint is obtained. In contrast, the matrix M1 used in the second embodiment has four rows and three columns and is calculated as a pseudo-inverse matrix. Thus, even when conversion based on Xi, Yi, and Zi is performed, no conditions of constraint, such as those in the first embodiment, are imposed on R2, G2, B2, and C2. According to the second embodiment, noise generated by these conditions of constraint (e.g., there may be some sort of unevenness because “G2=0” means that G is turned off or black) is suppressed. Therefore, according to the second embodiment, highly accurate color conversion can be performed.

Also in the second embodiment, color conversion of input image data is performed by performing interpolation calculation using the color conversion values. Thus, a gradation discontinuity that may occur at the boundary of the color reproduction region can be suppressed.

The color conversion value calculation may be performed by combining the methods according to the first and second embodiments. Specifically, color conversion values for certain Xi, Yi, and Zi may be obtained by the method according to the first embodiment using the divided regions, while color conversion values for other Xi, Yi, and Zi may be obtained by the method according to the second embodiment using the matrix. In this case, it is preferable that R2, G2, B2, and C2 for use in the matrix calculation according to the second embodiment be set using the divided regions, as in the method according to the first embodiment. This is to ensure continuity of color conversion values obtained by different methods.

The method of calculating the pseudo-inverse matrix M1 by setting R2, G2, B2, and C2 inside the color reproduction region and obtaining Xi, Yi, and Zi corresponding to R2, G2, B2, and C2 is, in other words, a calculation of the matrix M1 for outputting a set of R2, G2, B2, and C2 corresponding to a set of the input Xi, Yi, and Zi using the least-squares method. Thus, it is also possible that different R2, G2, B2, and C2 be set for different Xi, Yi, and Zi, thereby obtaining different matrices M1 that optimally approximate the associated Xi, Yi, and Zi.

Third Embodiment

A third embodiment of the invention will now be described. The third embodiment is different from the first embodiment in the number of predetermined points set in advance and solid bodies defined by the predetermined points. Specifically, in the third embodiment, eight predetermined points are used, and a cube with each edge having two predetermined points (a cube that has a predetermined point only at each vertex) is used. Unlike in the first embodiment, there is no difference between the first and second cubes, and there is only one cube. According to the third embodiment, instead of performing both the first region determination (see step S702 in FIG. 18) and the second region determination (see step S703 in FIG. 18) described above, a region determination (determination corresponding to the second region determination) is performed only once. That is, the first region determination and the reading of predetermined points are not performed in the third embodiment. The color conversion value calculation may be performed either by the method according to the first embodiment or the method according to the second embodiment. Thus, a description thereof is omitted.

FIG. 22 illustrates a solid body defined by the predetermined points according to the third embodiment. In this case, eight predetermined points 260 are arranged at equal intervals to form a cube. It is also assumed that this cube covers the color reproduction region. That is, a point indicating black is positioned inside the color reproduction region, and at least one of the predetermined points is positioned inside the color reproduction region. Since only one cube is defined in the third embodiment, a point 270 corresponding to input image data is always positioned inside the cube. It is thus unnecessary to perform a region determination to determine whether the point is positioned inside the cube.

Also in the third embodiment, the eight predetermined points 260 are defined as “t0 to t7”. The position (coordinates) of the input point 270 within the cube is defined as “r1, g1, b1”. As in the first embodiment, the cube is divided into tetrahedrons defined by the predetermined points t0 and t7 and two points selected from among the predetermined points ti to t6 (see FIGS. 16A to 16F). A tetrahedron in which the input image data is positioned is selected, and interpolation calculation is performed using color conversion values corresponding to each of the predetermined points defining the selected tetrahedron.

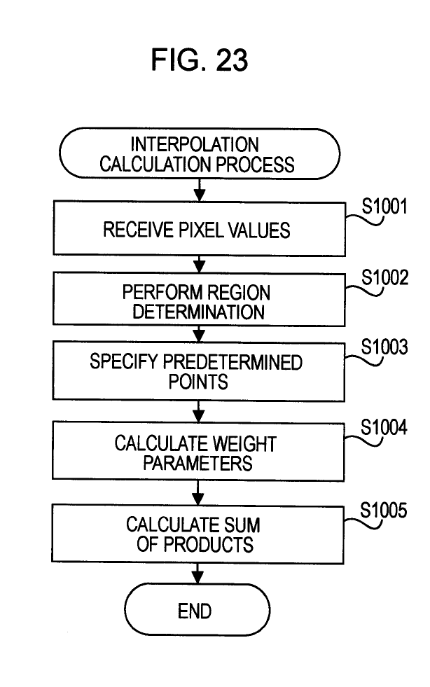

FIG. 23 is a flowchart showing an interpolation calculation process according to the third embodiment. The process is performed by the color converter 122 in the color conversion circuit 12 described above.

In step S1001, the color converter 122 obtains input image data. Specifically, the color converter 122 obtains R1, G1, and B1 of the input image data. Then, the flow proceeds to step S1002. In step S1002, the color converter 122 performs the region determination of the input image data. Specifically, the color converter 122 determines in which of the regions Ar20 to Ar25 (see FIGS. 16A to 16F) the input image data is contained on the basis of the conditions shown in the table of FIG. 17. Then, the flow proceeds to step S1003.

In step S1003, the color converter 122 specifies predetermined points defining the region selected in step S1002. Specifically, the color converter 122 obtains four points from among the predetermined points t0 to t7 and defines these four points as the points D0, DA, DB, and D7, respectively. Then, the flow proceeds to step S1004. In step S1004, the color converter 122 uses the table shown in FIG. 17 to calculate weight parameters WT0, WTA, WTB, and WT7 corresponding to the selected region using r1, g1, and b1 (weight calculation). Then, the flow proceeds to step S1005.

In step S1005, the color converter 122 obtains color conversion values for the predetermined points corresponding to the points D0, DA, DB, and D7, integrates the weight parameters WT0, WTA, WTB, and WT7 with the associated color conversion values, and adds the integrated values (the sum-of-products operation). Accordingly, color conversion of the input image data is performed. When the processing described above ends, the process exits from this flow.

Also in the third embodiment, color-conversion-value calculation serving as linear interpolation calculation can be accurately performed, and a gradation discontinuity between inside and outside the color reproduction region can be suppressed. In the third embodiment, the first region determination and the reading of the predetermined points (see step S702 in FIG. 18) are not performed. Thus, the circuit scale and the processing time can be reduced. Since the number of predetermined points is small, the volume of arrangement to be provided can be reduced, and the cost is thereby reduced.

Fourth Embodiment

A fourth embodiment of the invention will now be described. According to the fourth embodiment, the components of the multiple primary colors are different. That is, the fourth embodiment is different from the first embodiment in that white (hereinafter may also be abbreviated as “wh”) is used in the fourth embodiment instead of cyan. According to the fourth embodiment, methods similar to those according to the first to third embodiments are employed to perform color conversion for each predetermined point and interpolation calculation (see FIG. 8). Therefore, a description thereof is omitted.

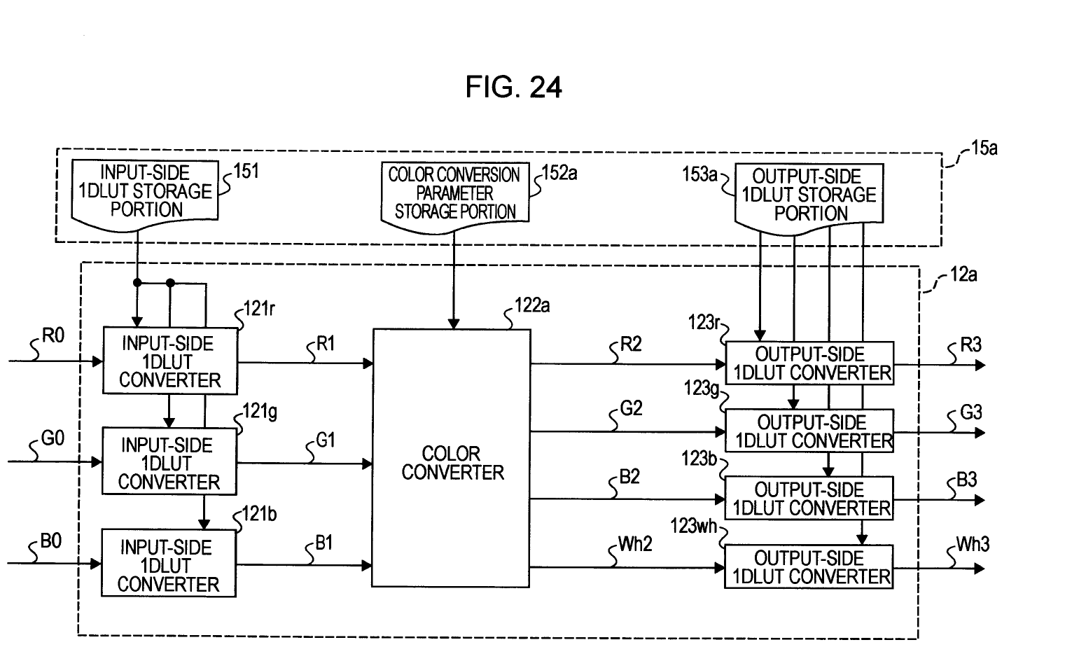

FIG. 24 is a block diagram showing the configuration of a color conversion circuit 12a and a table storage memory 15a according to the fourth embodiment. The color conversion circuit 12a is different from the color conversion circuit 12 according to the first embodiment in that the color conversion circuit 12a includes a color converter 122a instead of the color converter 122 and an output-side 1DLUT converter 123wh instead of the output-side 1DLUT converter 123c. The table storage memory 15a is different from the table storage memory 15 according to the first embodiment in that the table storage memory 15a includes a color conversion parameter storage portion 152a instead of the color conversion parameter storage portion 152 and an output-side 1DLUT storage portion 153a instead of the output-side 1DLUT storage portion 153. The same portions are referred to using the same reference numerals, and descriptions thereof are omitted. An image display apparatus including the color conversion circuit 12a and the table storage memory 15a according to the fourth embodiment can display images using the primary colors RGBWH.

The color converter 122a uses color conversion parameters stored in the color conversion parameter storage portion 152a to convert the supplied image data R1, G1, and B1 in which the three primary colors are changed to the four primary colors. Specifically, the color converter 122a performs color conversion in which the three primary colors RGB are changed to the four primary colors RGBWh additionally including white. The color converter 122a supplies color-converted image data R2, G2, B2, and Wh2 to the output-side 1DLUT converters 123r to 123wh, respectively. In this manner, the color converter 122a functions as a color-conversion-value calculator and a color converter.

The output-side 1DLUT 123r to 123wh perform output-side 1DLUT conversion of the image data R2, G2, B2, and Wh2 using the output-side 1DLUTs stored in the output-side 1DLUT storage portion 153a. The output-side 1DLUT converters 123r to 123wh output output-side-1DLUT-converted image data R3, G3, B3, and Wh3, respectively, to the VRAM 13. In this manner, the output-side 1DLUT converters 123r to 123wh function as a non-linearizer.

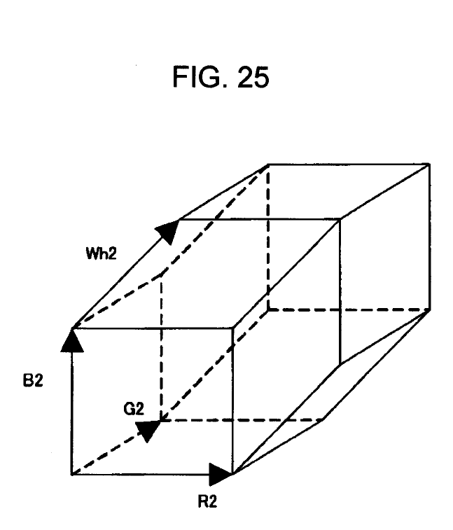

FIG. 25 shows an example of a color reproduction region defined by the primary colors including RGBWh. Specifically, the color reproduction region is represented as a dodecahedron defined by R2, G2, B2, and Wh2. In this case, Wh is the primary color positioned inside an RGB triangle in a chromaticity diagram.

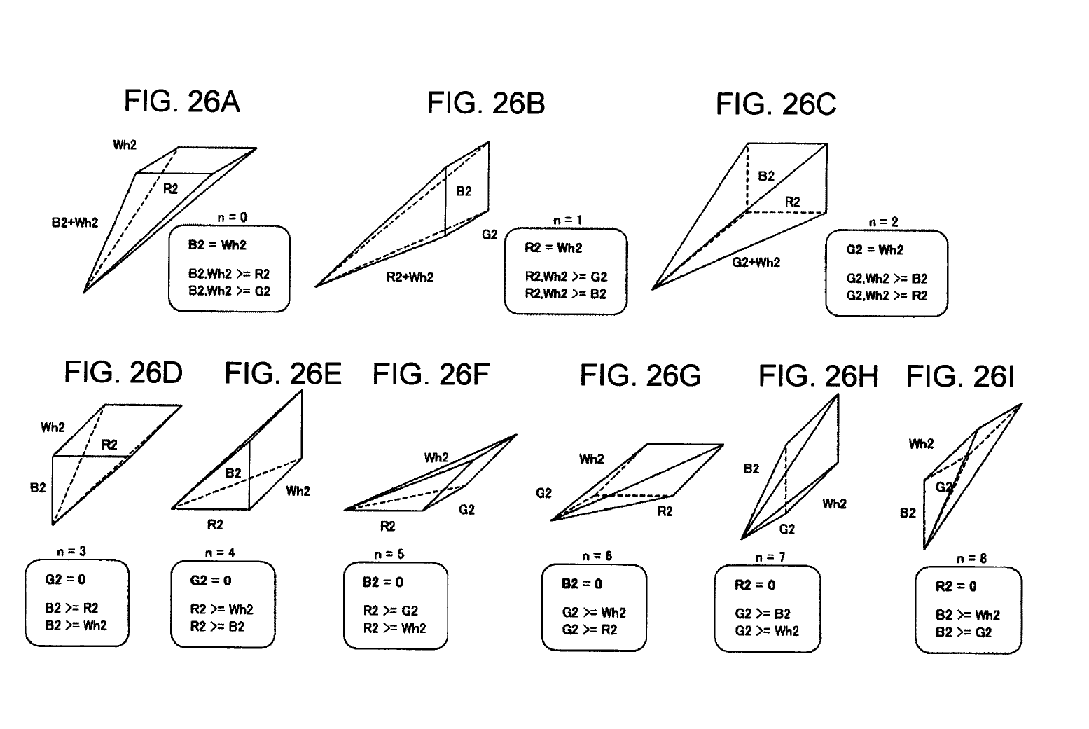

FIGS. 26A to 26I show color reproduction regions obtained by dividing the polyhedron according to the fourth embodiment. Specifically, FIGS. 26A to 26I are diagrams showing nine regions (quadrangular pyramids) obtained by dividing the dodecahedron shown in FIG. 25. Such division is performed by the color-reproduction-region dividing process shown in FIG. 7. Specifically, the primary colors of the color reproduction region are used to form outermost faces of the color reproduction region. In this case, the number of outermost faces is twelve since the number of primary colors is four. Next, faces that do not contain black are extracted. In the fourth embodiment, the number of faces that contain black is three since there is one primary color inside the color reproduction region. Thus, the number of faces that do not contain black is “12−3=9”. The faces that do not contain black can be represented as k-th, (k+1)-th, and (k+2)-th degree colors. Straight lines are drawn from black to the k-th, (k+1)-th, and (k+2)-th degree colors on the extracted faces that do not contain black. In the case of the four primary colors, the maximum degree is quaternary colors. Thus, the range of k is “1≦k≦2”. With these lines and the faces that do not contain black, the color reproduction region is divided to form solid bodies or, to be precise, quadrangular pyramids. That is, the color reproduction region is divided into nine quadrangular pyramids.

As has been described above, according to the fourth embodiment, the primary color reproduction values can be appropriately calculated by similarly performing color conversion for each predetermined point and interpolation calculation using the primary colors existing inside the RGB chromaticity. Thus, a gradation discontinuity at the boundary of the color reproduction region can be suppressed. Since the surface brightness is enhanced by using white as one of the primary colors, an image display apparatus that can display bright images can be achieved.

Fifth Embodiment

A fifth embodiment of the invention will now be described. According to the fifth embodiment, the components of the multiple primary colors are different. That is, the fifth embodiment is different from the first embodiment in that five primary colors including cyan and white in addition to RGB are used in the fifth embodiment. According to the fifth embodiment, methods similar to those according to the first to third embodiments are employed to perform color conversion for each predetermined point and interpolation calculation (see FIG. 8). Therefore, a description thereof is omitted.

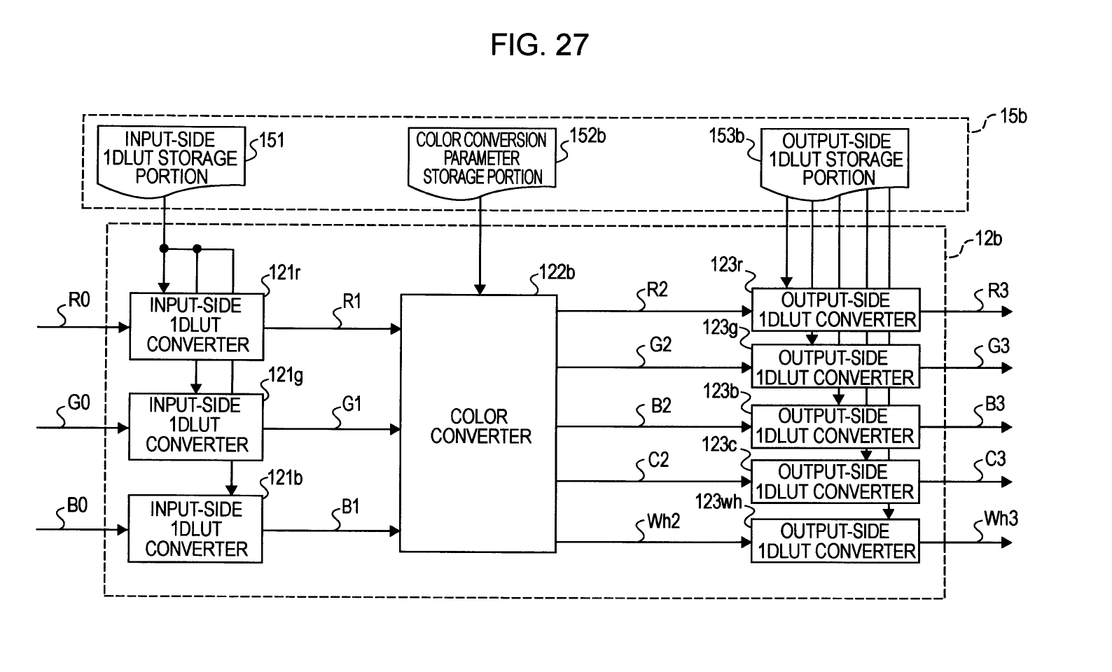

FIG. 27 is a block diagram showing the configuration of a color conversion circuit 12b and a table storage memory 15b according to the fifth embodiment. The color conversion circuit 12b is different from the color conversion circuit 12 according to the first embodiment in that the color conversion circuit 12b includes a color converter 122b instead of the color converter 122 and, not only the output-side 1DLUT converter 123c, the output-side 1DLUT converter 123wh. The table storage memory 15b is different from the table storage memory 15 according to the first embodiment in that the table storage memory 15b includes a color conversion parameter storage portion 152b instead of the color conversion parameter storage portion 152 and an output-side 1DLUT storage portion 153b instead of the output-side 1DLUT storage portion 153. The same portions are referred to using the same reference numerals, and descriptions thereof are omitted. An image display apparatus including the color conversion circuit 12b and the table storage memory 15b according to the fifth embodiment can display images using the five primary colors RGBCWh.

The color converter 122b uses color conversion parameters stored in the color conversion parameter storage portion 152b to convert the supplied image data R1, G1, and B1 in which the three primary colors are changed to the five primary colors. Specifically, the color converter 122b performs color conversion from the three primary colors RGB to the five primary colors RGBCWh additionally including cyan and white. The color converter 122b supplies color-converted image data R2, G2, B2, C2 , and Wh2 to the output-side 1DLUT converters 123r to 123wh, respectively. In this manner, the color converter 122b functions as a color-conversion-value calculator and a color converter.

The output-side 1DLUT 123r to 123wh perform output-side 1DLUT conversion of the image data R2, G2, B2, C2 , and Wh2 using the output-side 1DLUTs stored in the output-side 1DLUT storage portion 153b. The output-side 1DLUT converters 123r to 123wh output output-side-1DLUT-converted image data R3, G3, B3, C3, and Wh3, respectively, to the VRAM 13. In this manner, the output-side 1DLUT converters 123r to 123wh function as a non-linearizer.

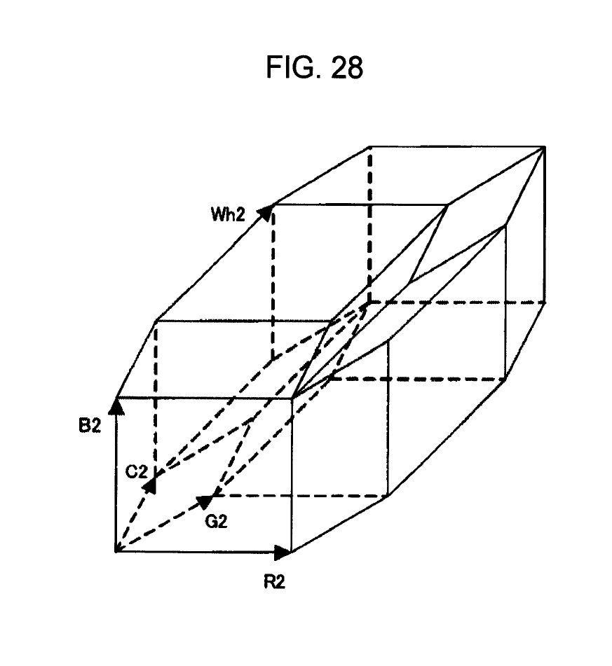

FIG. 28 shows an example of a color reproduction region defined by the five primary colors including RGBCWh. Specifically, the color reproduction region is represented as an icosahedron defined by the primary colors including R2, G2, B2, C2, and Wh2. In this case, Wh is the primary color positioned inside an RGBC rectangle in a chromaticity diagram.

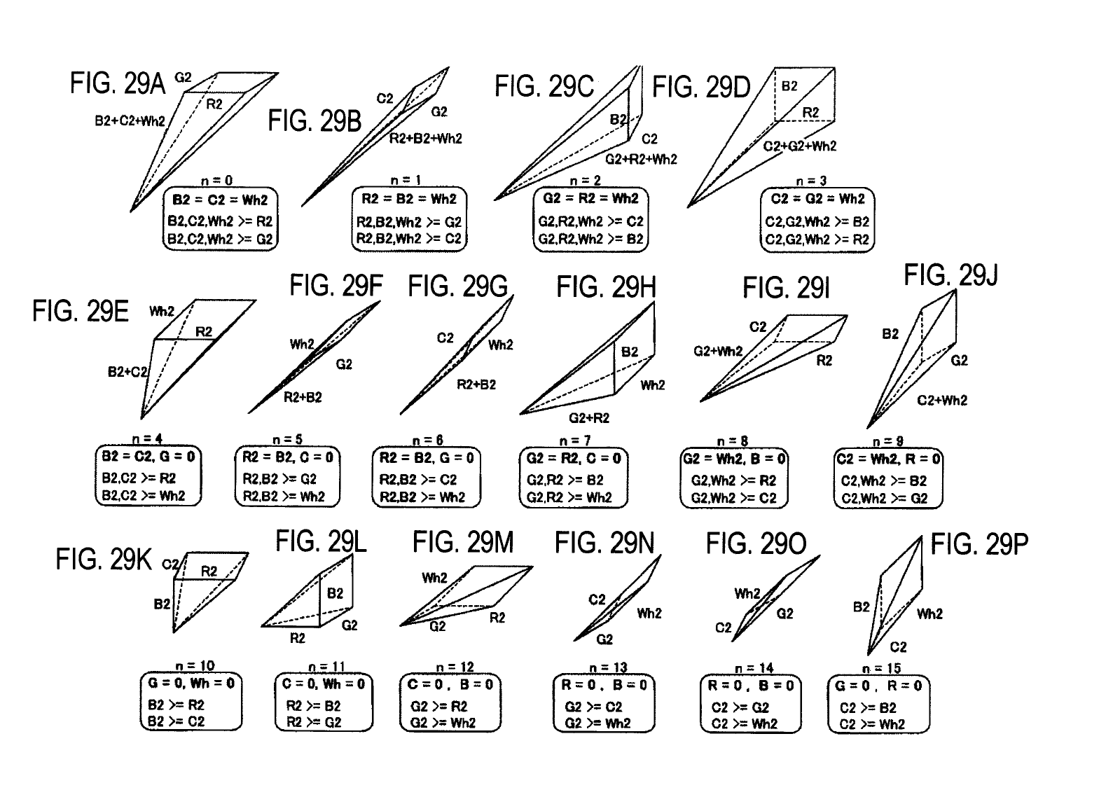

FIGS. 29A to 29P show color reproduction regions obtained by dividing the polyhedron according to the fifth embodiment. Specifically, FIGS. 29A to 29P are diagrams showing 16 regions (quadrangular pyramids) obtained by dividing the icosahedron shown in FIG. 28. Such division is performed by the color-reproduction-region dividing process shown in FIG. 7. Specifically, the primary colors of the color reproduction region are used to form outermost faces of the color reproduction region. In this case, the number of outermost faces is twenty since the number of primary colors is five. Next, faces that do not contain black are extracted. The number of faces that contain black is four since there is one primary color inside the color reproduction region. Thus, the number of faces that do not contain black is “20−4=16”. The faces that do not contain black can be represented as k-th, (k+1)-th, and (k+2)-th degree colors. Straight lines are drawn from black to the k-th, (k+1)-th, and (k+2)-th degree colors on the extracted faces that do not contain black. In the case of the five primary colors, the maximum degree is quinary colors. Thus, the range of k is “1≦k≦3”. With these lines and the faces that do not contain black, the color reproduction region is divided to form solid bodies or, to be precise, quadrangular pyramids. That is, the color reproduction region is divided into 16 quadrangular pyramids.

As has been described above, according to the fifth embodiment, the primary color reproduction values can be appropriately calculated by similarly performing color conversion for each predetermined point and interpolation calculation using the five primary colors RGBCWh. Thus, a gradation discontinuity at the boundary of the color reproduction region can be suppressed. Since cyan is used as one of the primary colors, vivid images can be displayed. Since white is used as one of the primary colors, the surface brightness can be enhanced. As a result, an image display apparatus that can display vivid and bright images can be achieved.

Modifications

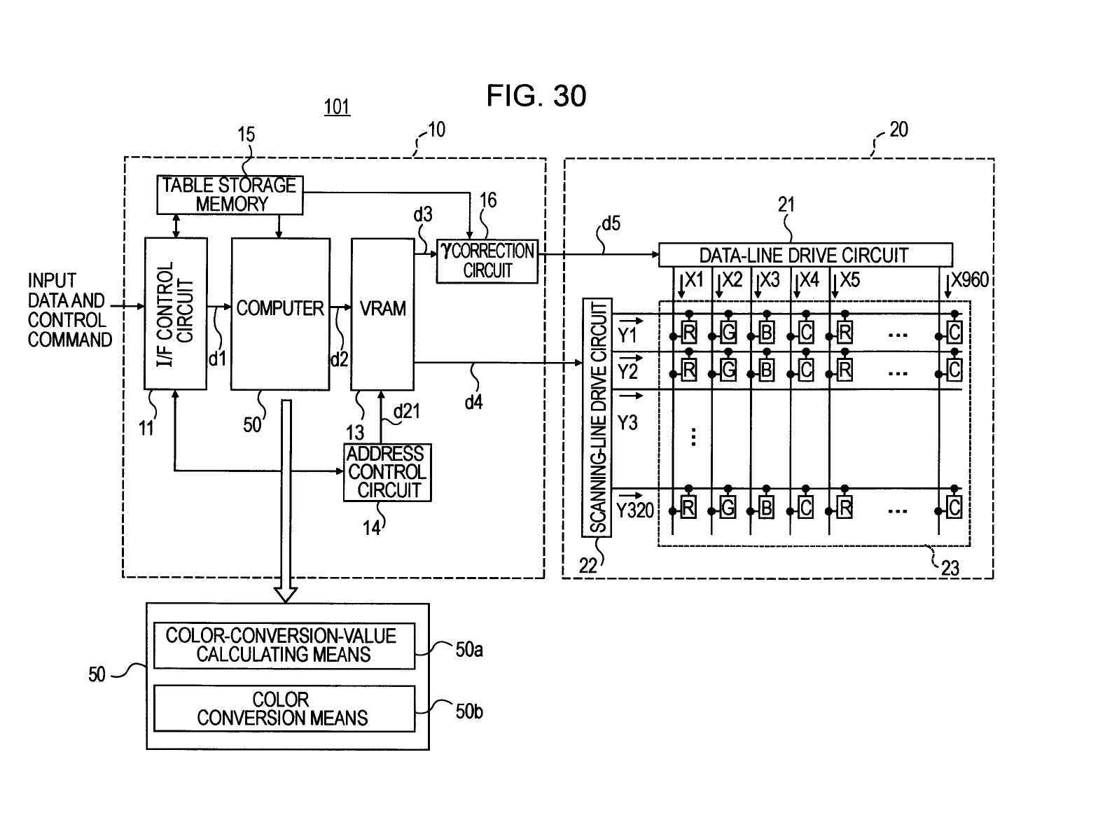

FIG. 30 is a block diagram showing the specific configuration of an image display apparatus 101 according to a modification of the invention. The image display apparatus 101 is different from the image display apparatus 100 (see FIG. 1) according to the first embodiment in that the image display apparatus 101 includes a computer 50 instead of the color conversion circuit 12. The computer 50 has a central processing unit (CPU), a memory, a read-only memory (ROM), or the like (none of which are shown). When the CPU in the computer 50 reads and executes a color conversion program stored on the ROM, the computer 50 functions as color-conversion-value calculating means 50a and color conversion means 50b to perform color conversion for each predetermined point and interpolation calculation (see FIG. 8) described above. That is, the computer 50 functions as a color converter. In this manner, the computer 50 writes color-converted image data to the VRAM 13.

The invention is not limited to the case where color conversion is performed by executing the color conversion program stored in the computer 50. Alternatively, the computer may read the color conversion program stored on a recording medium (optical disk or the like) to function as color-conversion-value calculating means and color conversion means, thereby performing color conversion for each predetermined point and interpolation calculation described above.

The invention is also applicable to an image display apparatus using primary colors (e.g., six primary colors), the number of which is greater than four or five. The invention is also applicable to an image display apparatus that does not include a VRAM.

The invention is not limited to the image display apparatus including an LCD. The invention is also applicable to an image display apparatus that performs planar display, such as a cathode-ray tube (CRT), a plasma display panel (PDP), an organic light-emitting diode (OLED), or a field emission display (FED), or to an image display apparatus that performs projection, such as a liquid crystal polymer (LCP) or a projection television (PTV)

Although the case where the plural colors used by the display device for displaying images include the primary colors such as R, G, B, and C has been described by way of specific example, the plural colors include, in addition to RGB, yellow (Y), cyan (C), and magenta (M) which are complementary colors of RGB, and intermediate colors, such as yellow green or dark green, between RGB and YCM.

Other Embodiments

Although the case where the plural colors (coloration regions) include RGBC has been described by way of example, the invention is not limited thereto. The above-described color conversion may be performed when one pixel includes coloration regions of other four colors.

In this case, the four coloration regions include, within a visible light region (380 to 780 nm) where hue changes according to wavelength, a bluish hue coloration region (may also be referred to as a “first coloration region”), a reddish hue coloration region (may also be referred to as a “second coloration region”), and two hue coloration regions selected from among hues ranging from blue to yellow (may also be referred to as a “third coloration region” and a “fourth coloration region”). The word “-ish” is used because, for example, the bluish hue is not limited to pure blue and includes violet, blue green, and the like. The reddish hue is not limited to red and includes orange. Each of the coloration regions may be formed by using a single coloration layer or by stacking a plurality of coloration layers of different hues. Although the coloration regions are described in terms of hue, hue is the color that can be set by appropriately changing the saturation and the value.

The specific range of each hue is as follows:
the bluish hue coloration region ranges from violet to blue green, and more preferably ranges from indigo to blue;
the reddish hue coloration region ranges from orange to red;
one of the two coloration regions selected from among hues ranging from blue to yellow ranges from blue to green, and more preferably ranges from blue green to green; and
the other coloration region selected from among hues ranging from blue to yellow ranges from green to orange, and more preferably ranges from green to yellow or from green to yellow green.

The coloration regions do not use the same hue. For example, when greenish hues are used in the two coloration regions selected from among hues ranging from blue to yellow, a green hue is used in one region, while a bluish hue or a yellow greenish hue is used in the other region.

Accordingly, a wider range of colors can be reproduced, compared with known RGB coloration regions.

By way of another specific example, the coloration regions may be described in terms of the wavelength of light passing therethrough:
the bluish coloration region is a coloration region where the peak of the wavelength of light passing therethrough is within 415-500 nm, and more preferably within 435-485 nm;
the reddish coloration region is a coloration region where the peak of the wavelength of light passing therethrough is greater than or equal to 600 nm, and more preferably greater than or equal to 605 nm;
one of the two coloration regions selected from among hues ranging from blue to yellow is a coloration region where the peak of the wavelength of light passing therethrough is within 485-535 nm, and more preferably within 495-520 nm; and
the other coloration region selected from among hues ranging from blue to yellow is a coloration region where the peak of the wavelength of light passing therethrough is within 500-590 nm, and more preferably within 510-585 nm or within 530-565 nm. These wavelengths are, in the case of transmission display, values obtained by allowing illumination light emitted from a lighting device to pass through color filters, and, in the case of reflection display, values obtained by allowing external light to be reflected.

By way of another specific example, the four coloration regions may be described in terms of the x, y chromaticity diagram:
the bluish coloration region is a coloration region where x≦0.151 and y≦0.200, more preferably x≦0.151 and y≦0.056, further preferably 0.134≦x≦0.151 and 0.034≦y≦0.200, and yet further preferably 0.134≦x≦0.151 and 0.034≦y≦0.056;
the reddish coloration region is a coloration region where 0.520≦x and y≦0.360, more preferably 0.643≦x and y≦0.333, further preferably 0.550≦x≦0.690 and 0.210≦y≦0.360, and yet further preferably 0.643≦x≦0.690 and 0.299≦y≦0.333;
one of the two coloration regions selected from among hues ranging from blue to yellow is a coloration region where x≦0.200 and 0.210≦y, more preferably x≦0.164 and 0.453≦y, further preferably 0.080≦x≦0.200 and 0.210≦y≦0.759, and yet further preferably 0.098≦x≦0.164 and 0.453≦y≦0.759; and
the other coloration region selected from among hues ranging from blue to yellow is a coloration region where 0.257≦x and 0.450≦y, more preferably 0.257≦x and 0.606≦y, further preferably 0.257≦x≦0.520 and 0.450≦y≦0.720, and yet further preferably 0.257≦x≦0.357 and 0.606≦y≦0.670.
   The x, y chromaticity diagram shows, in the case of transmission display, values obtained by allowing illumination light emitted from a lighting device to pass through color filters, and, in the case of reflection display, values obtained by allowing external light to be reflected.

When sub pixels are provided with transmission regions and reflection regions, the four coloration regions are also applicable to the transmission regions and the reflection regions within the above-described ranges.

When the four coloration regions in this example are used, an LED, a fluorescent lamp, or an organic electro-luminescence (organic EL) may be used as a backlight for RGB light sources. Alternatively, a white light source may be used. The white light source may be one generated using a blue illuminator and an yttrium aluminum garnet (YAG) phosphors.

Preferably, the RGB light sources are as follows:
for B, the peak of the wavelength is within 435-485 nm;
for G, the peak of the wavelength is within 520-545 nm; and
for R, the peak of the wavelength is within 610-650 nm. By appropriately selecting the above-described color filters on the basis of the wavelengths of the RGB light sources, a wide range of colors can be reproduced. Alternatively, a light source where the wavelength has a plurality of peaks, such as at 450 nm and 565 nm, may be used.

Specifically, the four coloration regions may include:
coloration regions where the hues are red, blue, green, and cyan (blue green);
coloration regions where the hues are red, blue, green, and yellow;
coloration regions where the hues are red, blue, dark green, and yellow;
coloration regions where the hues are red, blue, emerald green, and yellow green;
coloration regions where the hues are red, blue, emerald green, and yellow;
coloration regions where the hues are red, blue, dark green, and yellow green; and
coloration regions where the hues are red, blue green, dark green, and yellow green.

The entire disclosure of Japanese Patent Application No. 2005-303379, filed Oct. 18, 2005 and 2005-297057, filed Oct. 12, 2005 are expressly incorporated by reference herein.

What is claimed is:

1. A color conversion apparatus for performing color conversion of input image data in which a number of colors used in the input image data is changed to a number of colors used in a display device for displaying an image, the apparatus comprising:
a predetermined-point color-conversion-value calculator that calculates color conversion values corresponding to each of predetermined points in a color space, the predetermined points including a point outside a color reproduction region that can be displayed by the display device in the color space; and
an interpolation calculator that performs the color conversion by performing interpolation calculation on the input image data using the color conversion values corresponding to each of the predetermined points.

2. The color conversion apparatus according to claim 1, wherein the predetermined points at least include a point inside the color reproduction region.

3. The color conversion apparatus according to claim 1, wherein the interpolation calculator determines, on the basis of the input image data, a cube defined in the color space by the color conversion values corresponding to each of the predetermined points, obtains tetrahedrons by dividing the cube, and performs the interpolation calculation using the color conversion values corresponding to each of points defining each of the tetrahedrons.

4. The color conversion apparatus according to claim 1, wherein the predetermined-point color-conversion-value calculator performs the calculation based on the color reproduction region divided into predetermined regions.

5. The color conversion apparatus according to claim 1, wherein the predetermined-point color-conversion-value calculator calculates the color conversion values corresponding to each of the predetermined points using a conversion matrix for performing the color conversion in the color reproduction region.

6. The color conversion apparatus according to claim 5, wherein the conversion matrix is set using approximate points in the color reproduction region divided into predetermined regions.

7. The color conversion apparatus according to claim 1, wherein the color reproduction region defined by N number of colors is divided into “(N−1)−m” predetermined regions by obtaining “N(N−1)” outermost faces of the color reproduction region in the color space, extracting “N(N−1)−m” faces that do not contain black by excluding m (3 SmN) faces that contain black, and using quadrangular pyramids defined by k-th (1<k<-2), (k+1)-th, and (k+2)-th degree colors and black.

8. The color conversion apparatus according to claim 1, further comprising a linearizer that supplies image data obtained by linearizing the input image data to the predetermined-point color-conversion-value calculator and the interpolation calculator.

9. The color conversion apparatus according to claim 1, further comprising a non-linearizer that non-linearizes the color-converted image data.

10. The color conversion apparatus according to claim 1, wherein the predetermined points are 27 points arranged in a grid in the color space defined by the input colors.

11. The color conversion apparatus according to claim 1, wherein the predetermined points are eight points arranged in a grid in the color space defined by the input colors.

12. The color conversion apparatus according to claim 1, wherein the predetermined-point color-conversion-value calculator and the interpolation calculator output image data using four colors including red, green, blue, and cyan.

13. The color conversion apparatus according to claim 1, wherein the predetermined-point color-conversion-value calculator and the interpolation calculator output image data using four colors including red, green, blue, and white.

14. The color conversion apparatus according to claim 1, wherein the predetermined-point color-conversion-value calculator and the interpolation calculator output image data using five colors including red, green, blue, cyan, and white.

15. The color conversion apparatus according to claim 1, wherein colorant regions of the colors include, within a visible light region where hue changes according to wavelength, a bluish hue coloration region, a reddish hue coloration region, and two hue coloration regions selected from among hues ranging from blue to yellow.

16. The color conversion apparatus according to claim 1, wherein colorant regions of the colors include a coloration region where the peak of the wavelength of light passing therethrough is within 415-500 nm, a coloration region where the peak of the wavelength of light passing therethrough is greater than or equal to 600 nm, a coloration region where the peak of the wavelength of light passing therethrough is within 485-535 nm, and a coloration region where the peak of the wavelength of light passing therethrough is within 500-590 nm.

17. The color conversion apparatus according to claim 1, further comprising a storage device that stores the color conversion values calculated by the predetermined-point color-conversion-value calculator, wherein the interpolation calculator performs the color conversion based on the color conversion values stored in the storage device.

18. A color conversion method for performing color conversion of input image data in which the number of colors used in the input image data is changed to the number of colors used in a display device for displaying an image, the method comprising:
calculating color conversion values corresponding to each of predetermined points in a color space, the predetermined points including a point outside a color reproduction region that can be displayed by the display device in the color space; and
performing the color conversion by performing interpolation calculation on the input image data using the color conversion values corresponding to each of the predetermined points.

19. An image processing apparatus comprising:
a predetermined-point color-conversion-value calculator that calculates color conversion values corresponding to each of predetermined points in a color space, the predetermined points including a point outside a color reproduction region that can be displayed by a display device in the color space; and
an interpolation calculator that uses the color conversion values corresponding to each of the predetermined points to perform color conversion of input image data in which the number of colors used in the input image data is changed to the number of colors used in the display device for displaying an image.

20. An image display apparatus comprising:
an image processing apparatus as set forth in claim 19; and
a display device that displays image data that has been processed by the image processing apparatus.
